(19) United States
(12) Patent Application Publication
(10) Pub. No.: US 2011/0267821 A1
(43) Pub. Date: Nov. 3, 2011

(54) LIGHTING DEVICE WITH HEAT DISSIPATION ELEMENTS

(75) Inventors: Antony Paul VAN DE VEN, Hong Kong (CN); Gerald H. Negley, Durham, NC (US); Ian Darley, Sydney (AU); Martin Bertock, Brookvale (AU)

(73) Assignee: Cree, Inc., Durham, NC (US)

(21) Appl. No.: 13/022,142

(22) Filed: Feb. 7, 2011

Related U.S. Application Data
(60) Provisional application No. 61/303,789, filed on Feb. 12, 2010.

(51) Int. Cl. F21S 4/00; F21V 29/00

(52) U.S. Cl. 362/249.02

(57) ABSTRACT

A lighting device, comprising a solid state light emitter and first and second heat dissipation elements. In some devices, (1) the first heat dissipation element is in the path of at least some of the light emitted, (2) at least half of the 25% of the surface area of a first heat dissipation element that is closest to the first solid state light emitter is exposed, (3) at least part of a heat dissipation element is transparent or reflective, and a portion light from the light emitter goes in a specified range of directions, (4) angular size of gaps between heat dissipation elements are limited, and/or (5) at least 25% of heat generated by the light emitter(s) is dissipated in regions toward which light emitted by light emitter(s) is directed. Also, a lighting device comprising a solid state light emitter and means for dissipating heat.

### CROSS-REFERENCE TO RELATED APPLICATION

This application claims the benefit of U.S. Provisional Patent Application No. 61/303,789, filed Feb. 12, 2010, the entirety of which is incorporated herein by reference as if set forth in its entirety.

### FIELD OF THE INVENTIVE SUBJECT MATTER

The present inventive subject matter is directed to a lighting device that comprises one or more solid state light emitters (e.g., one or more light emitting diodes) and two or more heat dissipation elements. In some aspects, the present inventive subject matter is directed to such lighting devices in which at least a portion of a first heat dissipation element and at least a portion of a second heat dissipation element are in the path of at least some of the light emitted by the at least one solid state light emitter.

### BACKGROUND

There are a wide variety of light sources in existence, e.g., incandescent lights, fluorescent lamps, solid state light emitters, laser diodes, thin film electroluminescent devices, light emitting polymers (LEPs), halogen lamps, high intensity discharge lamps, electron-stimulated luminescence lamps, etc. The various types of light sources have been provided in a variety of shapes, sizes and arrangements, e.g., A lamps, B-10 lamps, BR lamps, C-7 lamps, C-15 lamps, ER lamps, F lamps, G lamps, K lamps, MB lamps, MR lamps, PAR lamps, PS lamps, R lamps, S lamps, S-11 lamps, T lamps, Linestra 2-base lamps, AR lamps, ED lamps, E lamps, BT lamps, Linear fluorescent lamps, U-shape fluorescent lamps, circline fluorescent lamps, single twin tube compact fluorescent lamps, double twin tube compact fluorescent lamps, triple twin tube compact fluorescent lamps, A-line compact fluorescent lamps, screw twist compact fluorescent lamps, globe screw base compact fluorescent lamps, reflector screw base compact fluorescent lamps, etc. The various types of light sources have been supplied with energy with an Edison connector, a battery connection, a GU24 connector, direct wiring to a branch circuit, etc. The various types of light sources have been designed so as to serve any of a variety of functions (e.g., as a flood light, as a spotlight, as a downlight, etc.), and have been used in residential, commercial or other applications.

With many light sources, there is a desire to effectively dissipate heat generated in generating light.

For example, with many incandescent light sources, about ninety percent of the electricity consumed is released as heat rather than light. There are many situations where effective heat dissipation is needed or desired for such incandescent light sources.

Solid state light emitters (e.g., light emitting diodes) are receiving much attention due to their energy efficiency. A challenge with solid state light emitters is that the performance of many solid state light emitters may be reduced when they are subjected to elevated temperatures. For example, many light emitting diode light sources have average operating lifetimes of decades (as opposed to just months or 1-2 years for many incandescent bulbs), but some light emitting diodes' lifetimes can be significantly shortened if they are operated at elevated temperatures. A common manufacturer recommendation is that the “junction temperature” (i.e., the temperature of the semiconductor junction of the LED) of a light emitting diode should not exceed 85 degrees C. if a long lifetime is desired. In order to ensure a junction temperature that is not above 85° C., various heat sinking schemes have been developed to dissipate at least some of the heat that is generated by the LED. See, for example, Application Note: CLD-APO6.006, entitled Cree® XLamp® XR Family & 4550 LED Reliability, published at cree.com/xlamp, September 2008.

In addition, the intensity of light emitted from some solid state light emitters varies based on operating temperature, and the variance in intensity resulting from changes in operating temperature can be more pronounced for solid state light emitters that emit light of one color than for solid state light emitters that emit light of another color. For example, light emitting diodes that emit red light often have a very strong temperature dependence (e.g., AIInGaP light emitting diodes can reduce in optical output by ˜20% when heated up by ˜40 degrees C., that is, approximately −0.5% per degree C.; and blue InGaN+YAG:Ce light emitting diodes can reduce by about −0.15%/degree C.). In many lighting devices that include solid state light emitters as light sources (e.g., general illumination devices that emit white light in which the light sources consist of light emitting diodes), a plurality of solid state light emitters are provided that emit light of different colors which, when mixed, are perceived as the desired color for the output light (e.g., white or near-white). The desire to maintain a relatively stable color of light output is therefore an important reason to try to reduce temperature variation of solid state light emitters.

In order to encourage development and deployment of highly energy efficient solid state lighting (SSL) products to replace several of the most common lighting products currently used in the United States, including 60-watt A19 incandescent and PAR 38 halogen incandescent lamps, the Bright Tomorrow Lighting Competition (L Prize™) has been authorized in the Energy Independence and Security Act of 2007 (EISA). The L Prize is described in “Bright Tomorrow Lighting Competition (L Prize™)”, May 28, 2008, Document No. 08NT006643, the disclosure of which is hereby incorporated herein by reference in its entirety as if set forth fully herein. The L Prize winner must conform to many product requirements including light output, wattage, color rendering index, correlated color temperature, expected lifetime, dimensions and base type.

Efforts have been ongoing to develop ways by which solid state light emitters can be used in place of incandescent lights, fluorescent lights and other light-generating devices in a wide variety of applications. In addition, where light emitting diodes (or other solid state light emitters) are already being used, efforts are ongoing to provide solid state light emitters that are improved, e.g., with respect to energy efficiency, color rendering index (CRI Ra), efficacy (1 m/W), and/or duration of service.

### BRIEF SUMMARY OF THE INVENTIVE SUBJECT MATTER

As noted above, in order to provide long lifetime with conventional LED light sources, it may be important to dissipate heat generated by the light source. This is typically done through a heat sink that is thermally coupled to the light source. However, as LED light sources are adapted to conventional lamp envelopes, such as in A lamps, PAR lamps and BR lamps, the available area for heat sinks may be reduced. Accordingly, a thermal management system that may be incorporated into conventional product configurations (e.g., lamp envelopes) would be beneficial. In some embodiments according to the present inventive subject matter, by providing heat dissipation elements that are reflective and/or transparent, they can be positioned in the path of light being emitted by the light emitter(s) in the device.

According to an aspect of the present inventive subject matter, there is provided a lighting device that comprises at least a first heat dissipation element and a second heat dissipation element.

According to another aspect of the present inventive subject matter, there is provided a lighting device that comprises at least a first solid state light emitter and at least first and second heat dissipation elements.

According to another aspect of the present inventive subject matter, there is provided a lighting device, comprising:

at least a first solid state light emitter; and

at least a first heat dissipation element and a second heat dissipation element,
the first heat dissipation element and the first solid state light emitter being positioned and oriented relative to one another such that if the first solid state light emitter is illuminated, at least a portion of the first heat dissipation element is in the path of at least some of the light emitted by the first solid state light emitter. In some embodiments in accordance with this aspect of the present inventive subject matter, at least a first portion of the first heat dissipation element is devoid of transparency (i.e., it is not transparent) and is in the path of at least some of the light emitted by the first solid state light emitter.

According to another aspect of the present inventive subject matter, there is provided a lighting device, comprising:

at least a first solid state light emitter; and

at least a first heat dissipation element and a second heat dissipation element, wherein at least half of the 25% (e.g., by volume) (and in some embodiments, 35%, 45%, 50%, 60%, 70%, 80%, 90% or 100%) of the surface area of the first heat dissipation element that is closest to the first solid state light emitter is exposed (e.g., to an ambient medium, such as room air).

According to another aspect of the present inventive subject matter, there is provided a lighting device, comprising:

at least a first solid state light emitter; and

at least first and second heat dissipation elements, at least a portion of at least one of the heat dissipation elements being transparent or reflective,

wherein at least 90 percent of all light emitted by the first solid state light emitter that exits the lighting device travels in directions that define angles that are not greater than 60degrees (or not greater than 50 degrees, 40 degrees, 35 degrees, 30 degrees, 25 degrees, 20 degrees, 15 degrees, 10 degrees, etc.) relative to a line that extends through the first solid state light emitter. In some of such embodiments, the line that extends through the first solid state light emitter is an axis of the lighting device.

According to another aspect of the present inventive subject matter, there is provided a lighting device, comprising:

at least a first solid state light emitter; and

at least first and second heat dissipation elements,
any line that passes through a center of the first solid state light emitter and a point on a hemisphere whose circular edge is (1) centered on the center of the first solid state light emitter and (2) positioned on a plane that is perpendicular to an axis of the lighting device, defines an angle of not more than 45 degrees (in some cases, not more than 30 degrees, and in some cases, not more than 15 degrees) relative to at least one line that passes through the center of the first solid state light emitter and at least one point on a heat dissipation element of the lighting device.

According to another aspect of the present inventive subject matter, there is provided a lighting device, comprising:

at least a first solid state light emitter; and

at least first and second heat dissipation elements,

wherein at least 25% (and in some embodiments, at least 35%, 45%, 50%, 60%, 70%, 80%, 90% or 100%) of heat generated by the at least one solid state light emitter is dissipated in regions toward which light emitted by the at least one solid state light emitter is directed.

According to another aspect of the present inventive subject matter, there is provided a lighting device, comprising:

at least a first solid state light emitter; and

means for dissipating heat (e.g., at least a first heat dissipation element and a second heat dissipation element as described herein).

According to another aspect of the present inventive subject matter, there is provided a lighting device, comprising:

at least a first solid state light emitter; and

at least a first heat dissipation element, at least a first portion of the first heat dissipation element devoid of transparency,
the first heat dissipation element and the first solid state light emitter being positioned and oriented relative to one another such that if the first solid state light emitter is illuminated, at least the first portion of the first heat dissipation element is in the path of at least some of the light emitted by the first solid state light emitter.

According to another aspect of the present inventive subject matter, there is provided a lighting device, comprising:

an electrical connector;

at least a first solid state light emitter; and

at least a first heat dissipation element, at least a portion of the first heat dissipation element on a first side of a first plane extending through the first solid state light emitter, the electrical connector on a second side of the first plane. In some embodiments in accordance with this aspect of the present inventive subject matter, at least a first portion of the first heat dissipation element devoid of transparency, and/or the first plane is an emission plane of the first solid state light emitter.

The inventive subject matter may be more fully understood with reference to the accompanying drawings and the following detailed description of the inventive subject matter.

### BRIEF DESCRIPTION OF THE DRAWING FIGURES

FIG. 1 is a first perspective view of a lighting device 10.

FIG. 2 is a second perspective view of the lighting device 10.

FIG. 3 is a cross-sectional view of a base 13 of the lighting device 10.

FIG. 4 depicts a first lateral heat dissipation element 22 of the lighting device 10.

FIG. 5 depicts a second lateral heat dissipation element 23 of the lighting device 10.

FIG. 6 depicts a base plate 16 of the lighting device 10.

FIG. 7 depicts a longitudinal heat dissipation element 11 of the lighting device 10.

FIG. 8 is a first perspective view of a lighting device 80.

FIG. 9 is a second perspective view of the lighting device 80.

FIG. 10 is a cross-sectional view of a base 113 for use in some lighting devices according to the present inventive subject matter.

### DETAILED DESCRIPTION OF THE INVENTIVE SUBJECT MATTER

The present inventive subject matter now will be described more fully hereinafter with reference to the accompanying drawings, in which embodiments of the inventive subject matter are shown. However, this inventive subject matter should not be construed as being limited to the embodiments set forth herein. Rather, these embodiments are provided so that this disclosure will be thorough and complete, and will fully convey the scope of the inventive subject matter to those skilled in the art. Like numbers refer to like elements throughout.

As used herein the term “and/or” includes any and all combinations of one or more of the associated listed items.

The terminology used herein is for the purpose of describing particular embodiments only and is not intended to be limiting of the inventive subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

When an element such as a layer, region or substrate is referred to herein as being “on”, being mounted “on” or extending “onto” another element, it can be directly on or extend directly onto the other element or intervening elements may also be present. In contrast, when an element is referred to herein as being “directly on” or extending “directly onto” another element, there are no intervening elements present. Also, when an element is referred to herein as being “connected” or “coupled” to another element, it can be directly connected or coupled to the other element or intervening elements may be present. In contrast, when an element is referred to herein as being “directly connected” or “directly coupled” to another element, there are no intervening elements present. In addition, a statement that a first element is “on” a second element is synonymous with a statement that the second element is “on” the first element.

The expression “in contact with”, as used herein, means that the first structure that is in contact with a second structure is in direct contact with the second structure or is in indirect contact with the second structure. The expression “in indirect contact with” means that the first structure is not in direct contact with the second structure, but that there are a plurality of structures (including the first and second structures), and each of the plurality of structures is in direct contact with at least one other of the plurality of structures (e.g., the first and second structures are in a stack and are separated by one or more intervening layers). The expression “direct contact”, as used in the present specification, means that the first structure which is “in direct contact” with a second structure is touching the second structure and there are no intervening structures between the first and second structures at least at some location.

A statement herein that two components in a device are “electrically connected,” means that there are no components electrically between the components that affect the function or functions provided by the device. For example, two components can be referred to as being electrically connected, even though they may have a small resistor between them which does not materially affect the function or functions provided by the device (indeed, a wire connecting two components can be thought of as a small resistor); likewise, two components can be referred to as being electrically connected, even though they may have an additional electrical component between them which allows the device to perform an additional function, while not materially affecting the function or functions provided by a device which is identical except for not including the additional component; similarly, two components which are directly connected to each other, or which are directly connected to opposite ends of a wire or a trace on a circuit board, are electrically connected. A statement herein that two components in a device are “electrically connected” is distinguishable from a statement that the two components are “directly electrically connected”, which means that there are no components electrically between the two components.

Although the terms “first”, “second”, etc. may be used herein to describe various elements, components, regions, layers, sections and/or parameters, these elements, components, regions, layers, sections and/or parameters should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive subject matter.

Relative terms, such as “lower”, “bottom”, “below”, “upper”, “top”, “above,” “horizontal” or “vertical” may be used herein to describe one element's relationship to another elements as illustrated in the Figures. Such relative terms are intended to encompass different orientations of the device in addition to the orientation depicted in the Figures. For example, if the device in the Figures is turned over, elements described as being on the “lower” side of other elements would then be oriented on “upper” sides of the other elements. The exemplary term “lower”, can therefore, encompass both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

The term “illumination” (or “illuminated”), as used herein when referring to a solid state light emitter means that at least some current is being supplied to the solid state light emitter to cause the solid state light emitter to emit at least some electromagnetic radiation (in some cases, with at least a portion of the emitted radiation having a wavelength between 100 nm and 1000 nm, and in some cases within the visible spectrum). The expression “illuminated” also encompasses situations where the light source emits light continuously or intermittently at a rate such that if it is or was visible light, a human eye would perceive it as emitting light continuously (or discontinuously), or where a plurality of light sources (especially in the case of solid state light emitters) that emit light of the same color or different colors are emitting light intermittently and/or alternatingly (with or without overlap in “on” times) in such a way that if they were or are visible light, a human eye would perceive them as emitting light continuously or discontinuously (and, in cases where different colors are emitted, as a mixture of those colors).

The expression “excited”, as used herein when referring to luminescent material, means that at least some electromagnetic radiation (e.g., visible light, UV light or infrared light) is contacting the luminescent material, causing the luminescent material to emit at least some light. The expression “excited” encompasses situations where the luminescent material emits light continuously, or intermittently at a rate such that a human eye would perceive it as emitting light continuously or intermittently, or where a plurality of luminescent materials that emit light of the same color or different colors are emitting light intermittently and/or alternatingly (with or without overlap in “on” times) in such a way that a human eye would perceive them as emitting light continuously or intermittently (and, in some cases where different colors are emitted, as a mixture of those colors).

The expression “lighting device”, as used herein, is not limited, except that it indicates that the device is capable of emitting light. That is, a lighting device can be a device which illuminates an area or volume, e.g., a structure, a swimming pool or spa, a room, a warehouse, an indicator, a road, a parking lot, a vehicle, signage, e.g., road signs, a billboard, a ship, a toy, a mirror, a vessel, an electronic device, a boat, an aircraft, a stadium, a computer, a remote audio device, a remote video device, a cell phone, a tree, a window, an LCD display, a cave, a tunnel, a yard, a lamppost, or a device or array of devices that illuminate an enclosure, or a device that is used for edge or back-lighting (e.g., back light poster, signage, LCD displays), bulb replacements (e.g., for replacing AC incandescent lights, low voltage lights, fluorescent lights, etc.), lights used for outdoor lighting, lights used for security lighting, lights used for exterior residential lighting (wall mounts, post/column mounts), ceiling fixtures/wall sconces, under cabinet lighting, lamps (floor and/or table and/or desk), landscape lighting, track lighting, task lighting, specialty lighting, ceiling fan lighting, archival/art display lighting, high vibration/impact lighting—work lights, etc., mirrors/vanity lighting, or any other light emitting device.

The expression “transparent”, as used herein, means that the structure which is characterized as being transparent allows passage of at least 90% of incident visible light.

The expression “thermally coupled”, as used herein, means that heat transfer occurs between (or among) the two (or more) items that are thermally coupled. Such heat transfer encompasses any and all types of heat transfer, regardless of how the heat is transferred between or among the items. That is, the heat transfer between (or among) items can be by conduction, convection, radiation, or any combinations thereof, and can be directly from one of the items to the other, or indirectly through one or more intervening elements or spaces (which can be solid, liquid and/or gaseous) of any shape, size and composition. The expression “thermally coupled” encompasses structures that are “adjacent” (as defined herein) to one another. In some situations/embodiments, the majority of the heat transferred from the light source is transferred by conduction; in other situations / embodiments, the majority of the heat that is transferred from the light source is transferred by convection; and in some situations/embodiments, the majority of the heat that is transferred from the light source is transferred by a combination of conduction and convection.

The expression “primary axis of emission”, as used herein in connection with light output from one or more light emitters, means an axis of the light emission from the light emitter, a direction of maximum brightness of light emission, or a mean direction of light emission (in other words, if the maximum brightness is in a first direction, but a brightness in a second direction ten degrees to one side of the first direction is larger than a brightness in a third direction ten degrees to an opposite side of the first direction, the mean direction of light emission would be moved somewhat toward the second direction as a result of the brightnesses in the second direction and the third direction).

The expression “emission plane” (e.g., “emission plane of a solid state light emitter”), as used herein, means (1) a plane that is perpendicular to an axis of the light emission from the solid state light emitter (e.g., in a case where light emission is hemispherical, the plane would be along the flat part of the hemisphere; in a case where light emission is conical, the plane would be perpendicular to the axis of the cone), (2) a plane that is perpendicular to a direction of maximum brightness of light emission from the solid state light emitter (e.g., in a case where the maximum light emission is vertical, the plane would be horizontal), (3) a plane that is perpendicular to a mean direction of light emission (in other words, if the maximum brightness is in a first direction, but a brightness in a second direction ten degrees to one side of the first direction is larger than a brightness in a third direction ten degrees to an apposite side of the first direction, the mean direction of light emission would be moved somewhat toward the second direction as a result of the brightnesses in the second direction and the third direction).

The present inventive subject matter further relates to an illuminated enclosure (the volume of which can be illuminated uniformly or non-uniformly), comprising an enclosed space and at least one lighting device according to the present inventive subject matter, wherein the lighting device illuminates at least a portion of the enclosed space (uniformly or non-uniformly).

Some embodiments of the present inventive subject matter are directed to a structure comprising a surface and at least one lighting device corresponding to any embodiment of a lighting device according to the present inventive subject matter as described herein, wherein if current is supplied to a first power line, and/or if at least one solid state light emitter in the lighting device is illuminated, the lighting device would illuminate at least a portion of the surface.

The present inventive subject matter is further directed to an illuminated area, comprising at least one item, e.g., selected from among the group consisting of a structure, a swimming pool or spa, a room, a warehouse, an indicator, a road, a parking lot, a vehicle, signage, e.g., road signs, a billboard, a ship, a toy, a mirror, a vessel, an electronic device, a boat, an aircraft, a stadium, a computer, a remote audio device, a remote video device, a cell phone, a tree, a window, an LCD display, a cave, a tunnel, a yard, a lamppost, etc., having mounted therein or thereon at least one lighting device as described herein.

The term “reflective”, as used herein, means that the structure (or region of a structure) that is characterized as being reflective reflects at least 70% of incident visible light.

Unless otherwise defined, all terms (including technical and scientific terms) used herein have the same meaning as commonly understood by one of ordinary skill in the art to which this inventive subject matter belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein. It will also be appreciated by those of skill in the art that references to a structure or feature that is disposed “adjacent” another feature may have portions that overlap or underlie the adjacent feature.

As noted above, some embodiments of the present inventive subject matter relate to a lighting device that comprises at least a first solid state light emitter and at least a first heat dissipation element and a second heat dissipation element.

In some embodiments according to the present inventive subject matter, which can include or not include any of the features described elsewhere herein, at least 20% (and in some embodiments, at least 30%, 40%, 50%, 60%, 70%, 80% or 90%) of a volume defined by an exterior of the lighting device is exposed, e.g., to an ambient medium, such as air.

In some embodiments according to the present inventive subject matter, which can include or not include any of the features described elsewhere herein, at least half of the 25% (and in some embodiments, 35%, 45%, 50%, 60%, 70%, 80%, 90% or 100%) of the surface area of the first heat dissipation element that is closest to the first solid state light emitter is exposed (e.g., to an ambient medium, such as room air).

In some embodiments according to the present inventive subject matter, which can include or not include any of the features described elsewhere herein, at least 90 percent of all light emitted by the first solid state light emitter that exits the lighting device travels in directions that define angles that are not greater than 60 degrees relative to a line that extends through the first solid state light emitter. In some of such embodiments, the line that extends through the first solid state light emitter is an axis of the lighting device.

In some embodiments according to the present inventive subject matter, which can include or not include any of the features described elsewhere herein, any line that passes through a center of the first solid state light emitter and a point on a hemisphere whose circular edge is (1) centered on the center of the first solid state light emitter and (2) positioned on a plane that is perpendicular to an axis of the lighting device defines an angle of not more than 45 degrees (in some cases, not more than 30 degrees, and in some cases, not more than 15 degrees) relative to at least one line that passes through the center of the first solid state light emitter and at least one point on a heat dissipation element of the lighting device.

In some embodiments according to the present inventive subject matter, which can include or not include any of the features described elsewhere herein, the first solid state light emitter is exposed to an ambient medium (e.g., room air) that is outside the lighting device. In some of such embodiments, the ambient medium can reach the solid state light emitter in at least fifteen different routes that are separated from each other by at least one heat dissipation element.

In some embodiments according to the present inventive subject matter, which can include or not include any of the features described elsewhere herein:
at least 25 percent of light emitted by the first solid state light emitter is incident on one of the heat dissipation elements, and
at least 50 percent of the light emitted by the first solid state light emitter that is incident on one of the heat dissipation elements eventually exits the lighting device.

In some embodiments according to the present inventive subject matter, which can include or not include any of the features described elsewhere herein, at least 25% (and in some embodiments, at least 35%, 45%, 50%, 60%, 70%, 80%, 90% or 100%) of heat generated by the first solid state light emitter is dissipated in regions toward which light emitted by the at least one solid state light emitter is directed.

In some embodiments according to the present inventive subject matter, which can include or not include any of the features described elsewhere herein, at least 75% (and in some embodiments, at least 80%, 85%, 90% or 95%) of all of the light emitted by the first solid state light emitter that exits the lighting device passes through at least one heat dissipation element, is reflected by at least one heat dissipation element or passes within one inch (and in some cases, within ½ inch) of at least one heat dissipation element.

In some embodiments according to the present inventive subject matter, which can include or not include any of the features described elsewhere herein, at least 50% (and in some embodiments, at least 60%, 70%, 80% or 90%) of an entire external surface area of the first heat dissipation element and at least 50% (and in some embodiments, at least 60%, 70%, 80% or 90%) of an entire external surface area of the second heat dissipation element are exposed.

In some embodiments according to the present inventive subject matter, which can include or not include any of the features described elsewhere herein, at least 50% (and in some embodiments, at least 60%, 70%, 80% or 90%) of an entire external surface area of the first heat dissipation element and at least 50% (and in some embodiments, at least 60%, 70%, 80% or 90%) of an entire external surface area of the second heat dissipation element are exposed to an ambient medium outside the lighting device.

In some embodiments according to the present inventive subject matter, which can include or not include any of the features described elsewhere herein, a first line extending through a center of the first solid state light emitter and a center of gravity of the first heat dissipation element and a second line extending through a center of the first solid state light emitter and a center of gravity of the second heat dissipation element define an angle of not more than 80 degrees.

In some embodiments according to the present inventive subject matter, which can include or not include any of the features described elsewhere herein:
the first heat dissipation element has a first surface in a first plane,
the second heat dissipation element has a second surface in a second plane, and
the first plane defines an angle of between 5 degrees and 80 degrees relative to the second plane, and:

in some of such embodiments, the first plane and the second plane each include an axis of the lighting device;

in some of such embodiments:
the lighting device comprises at least a third heat dissipation element, a fourth heat dissipation element and a fifth heat dissipation element in addition to the first heat dissipation element and the second heat dissipation element,
the third heat dissipation element has a third surface in a third plane,
the fourth heat dissipation element has a fourth surface in a fourth plane,
the fifth heat dissipation element has a fifth surface in a fifth plane, and
each of the first plane, the second plane, the third plane, the fourth plane and the fifth plane defines an angle of not more than 80 degrees with respect to each of the others of the first plane, the second plane, the third plane, the fourth plane and the fifth plane. In some of such embodiments, the first plane, the second plane, the third plane, the fourth plane and the fifth plane each include an axis of the lighting device; and

in some of such embodiments:
the lighting device comprises at least a third heat dissipation element, a fourth heat dissipation element, a fifth heat dissipation element, a sixth heat dissipation element, a seventh heat dissipation element and an eighth heat dissipation element in addition to the first heat dissipation element and the second heat dissipation element,
the third heat dissipation element has a third surface in a third plane,
the fourth heat dissipation element has a fourth surface in a fourth plane,
the fifth heat dissipation element has a fifth surface in a fifth plane,
the sixth heat dissipation element has a sixth surface in a sixth plane,
the seventh heat dissipation element has a seventh surface in a seventh plane,
the eighth heat dissipation element has an eighth surface in an eighth plane, and
each of the first plane, the second plane, the third plane, the fourth plane, the fifth plane, the sixth plane, the seventh plane and the eighth plane defines an angle of not more than 80 degrees with respect to each of the others of the first plane, the second plane, the third plane, the fourth plane, the fifth plane, the sixth plane, the seventh plane and the eighth plane. In some of such embodiments, the first plane, the second plane, the third plane, the fourth plane, the fifth plane, the sixth plane, the seventh plane and the eighth plane each include an axis of the lighting device.

In some embodiments according to the present inventive subject matter, which can include or not include any of the features described elsewhere herein, at least a portion of at least one of the heat dissipation elements is transparent or reflective.

In some embodiments according to the present inventive subject matter, which can include or not include any of the features described elsewhere herein, if the first solid state light emitter is illuminated, at least some light emitted by the at least a first solid state light emitter exits the lighting device in a first direction and at least some light emitted by the at least a first solid state light emitter exits the lighting device in a second direction, the first direction defining an angle of at least 90 degrees relative to the second direction.

In some embodiments according to the present inventive subject matter, which can include or not include any of the features described elsewhere herein, if the first solid state light emitter is illuminated, at least some light emitted by the at least a first solid state light emitter exits the lighting device in a first direction and at least some light emitted by the at least a first solid state light emitter exits the lighting device in a second direction, the first direction defining an angle of at least 160 degrees relative to the second direction.

In some embodiments according to the present inventive subject matter, which can include or not include any of the features described elsewhere herein:
at least a portion of at least one heat dissipation element is positioned in each of eight quadrants defined by first, second, third and fourth planes, each of the first, second, third and fourth planes including an axis of the lighting device, the second plane being rotated clockwise 45 degrees relative to the first plane, the third plane being rotated clockwise 45 degrees relative to the second plane, the fourth plane being rotated clockwise 45 degrees relative to the third plane, whereby the first, second, third and fourth planes are evenly spaced, and
no heat dissipation element includes portions that are positioned in each of three or more of the eight quadrants.

In some embodiments according to the present inventive subject matter, which can include or not include any of the features described elsewhere herein:
at least one heat dissipation element is positioned in each of eight quadrants defined by first, second, third and fourth planes, each of the first, second, third and fourth planes including an axis of the lighting device and being evenly radially spaced, and
no heat dissipation element includes portions that are positioned in each of two or more of the eight quadrants.

In some embodiments according to the present inventive subject matter, which can include or not include any of the features described elsewhere herein:
at least a portion of at least one heat dissipation element is positioned in each of sixteen quadrants defined by first through eighth planes, each of the first through eighth planes including an axis of the lighting device and being evenly radially spaced, and
no heat dissipation element includes portions that are positioned in each of three or more of the sixteen quadrants.

In some embodiments according to the present inventive subject matter, which can include or not include any of the features described elsewhere herein:
at least one heat dissipation element is positioned in each of sixteen quadrants defined by first through eighth planes, each of the first through eighth planes including an axis of the lighting device and being evenly radially spaced, and
no heat dissipation element includes portions that are positioned in each of two or more of the sixteen quadrants.

In some embodiments according to the present inventive subject matter, which can include or not include any of the features described elsewhere herein:
at least a portion of at least one heat dissipation element is positioned in each of thirty-two quadrants defined by first through sixteenth planes, each of the first through sixteenth planes including an axis of the lighting device and being evenly radially spaced, and
no heat dissipation element includes portions that are positioned in each of three or more of the thirty-two quadrants.

In some embodiments according to the present inventive subject matter, which can include or not include any of the features described elsewhere herein:
at least one heat dissipation element is positioned in each of thirty-two quadrants defined by first through sixteenth planes, each of the first through sixteenth planes including an axis of the lighting device and being evenly radially spaced, and
no heat dissipation element includes portions that are positioned in each of two or more of the thirty-two quadrants.

In some embodiments according to the present inventive subject matter, which can include or not include any of the features described elsewhere herein, a lighting device is provided that comprises at least two heat dissipation elements (and in some embodiments, at least four heat dissipation elements, at least eight heat dissipation elements, at least twelve heat dissipation elements, at least sixteen heat dissipation elements, at least twenty heat dissipation elements, at least twenty-four heat dissipation elements, at least twenty-eight heat dissipation elements, at least thirty-two heat dissipation elements, at least forty heat dissipation elements, at least forty-eight heat dissipation elements, at least fifty-six heat dissipation elements, at least sixty-four heat dissipation elements, etc.) that are substantially evenly radially spaced, i.e., each angle defined between a surface of a heat dissipation element and a surface of another heat dissipation element that is nearest is within 10 percent of every other angle defined between a surface of another heat dissipation element that is nearest.

In some embodiments according to the present inventive subject matter, which can include or not include any of the features described elsewhere herein, the lighting device is an A lamp (i.e., it meets the dimensional constraints for a lighting device to be characterized as an A lamp). An infinite number of varieties of lighting devices can be provided that fall within the definition of A lamps. For example, a number of different varieties of conventional A lamps exist and include those identified as A 15 lamps, A 17 lamps, A 19 lamps, A 21 lamps and A 23 lamps. The expression “A lamp” as used herein includes any lighting device that satisfies the dimensional characteristics for A lamps as defined in ANSI C78.20-2003, including the conventional A lamps identified in the preceding sentence. The lighting devices according to the present inventive subject matter can satisfy (or not satisfy) any or all of the other characteristics for A lamps (defined in ANSI C78.20-2003).

As noted above, some embodiments of the present inventive subject matter relate to a lighting device that comprises at least a first solid state light emitter and at least a first heat dissipation element and a second heat dissipation element.

A variety of solid state light emitters are well known, and any of such light emitters can be employed according to the present inventive subject matter. Representative examples of solid state light emitters include light emitting diodes (inorganic or organic, including polymer light emitting diodes (PLEDs)) with or without luminescent materials and thin film electroluminescent devices.

Persons of skill in the art are familiar with, and have ready access to, a variety of solid state light emitters that emit light having a desired peak emission wavelength and/or dominant emission wavelength, and any of such solid state light emitters (discussed in more detail below), or any combinations of such solid state light emitters, can be employed in embodiments that comprise a solid state light emitter.

Light emitting diodes are semiconductor devices that convert electrical current into light. A wide variety of light emitting diodes are used in increasingly diverse fields for an ever-expanding range of purposes. More specifically, light emitting diodes are semiconducting devices that emit light (ultraviolet, visible, or infrared) when a potential difference is applied across a p-n junction structure. There are a number of well known ways to make light emitting diodes and many associated structures, and the present inventive subject matter can employ any such devices.

A light emitting diode produces light by exciting electrons across the band gap between a conduction band and a valence band of a semiconductor active (light-emitting) layer. The electron transition generates light at a wavelength that depends on the band gap. Thus, the color of the light (wavelength) (and/or the type of electromagnetic radiation, e.g., infrared light, visible light, ultraviolet light, near ultraviolet light, etc., and any combinations thereof) emitted by a light emitting diode depends on the semiconductor materials of the active layers of the light emitting diode.

The expression “light emitting diode” is used herein to refer to the basic semiconductor diode structure (i.e., the chip). The commonly recognized and commercially available “LED” that is sold (for example) in electronics stores typically represents a “packaged” device made up of a number of parts. These packaged devices typically include a semiconductor based light emitting diode such as (but not limited to) those described in U.S. Pat. Nos. 4,918,487; 5,631,190; and 5,912,477; various wire connections, and a package that encapsulates the light emitting diode.

Lighting devices or lighting arrangements according to the present inventive subject matter can, if desired, further comprise one or more luminescent materials.

A luminescent material is a material that emits a responsive radiation (e.g., visible light) when excited by a source of exciting radiation. In many instances, the responsive radiation has a wavelength that is different from the wavelength of the exciting radiation.

Luminescent materials can be categorized as being down-converting, i.e., a material that converts photons to a lower energy level (longer wavelength) or up-converting, i.e., a material that converts photons to a higher energy level (shorter wavelength).

One type of luminescent material are phosphors, which are readily available and well known to persons of skill in the art. Other examples of luminescent materials include scintillators, day glow tapes and inks that glow in the visible spectrum upon illumination with ultraviolet light.

Persons of skill in the art are familiar with, and have ready access to, a variety of luminescent materials that emit light having a desired peak emission wavelength and/or dominant emission wavelength, or a desired hue, and any of such luminescent materials, or any combinations of such luminescent materials, can be employed, if desired.

The one or more luminescent materials can be provided in any suitable form. For example, the luminescent element can be embedded in a resin (i.e., a polymeric matrix), such as a silicone material, an epoxy material, a glass material or a metal oxide material, and/or can be applied to one or more surfaces of a resin, to provide a lumiphor.

The one or more solid state light emitters (and optionally one or more luminescent materials) can be arranged in any suitable way.

Representative examples of suitable solid state light emitters, including suitable light emitting diodes, luminescent materials, lumiphors, encapsulants, etc. that may be used in practicing the present inventive subject matter, are described in:

U.S. patent application Ser. No. 11/614,180, filed Dec. 21, 2006 (now U.S. Patent Publication No. 2007/0236911) (attorney docket number P0958; 931-003 NP), the entirety of which is hereby incorporated by reference as if set forth in its entirety;

U.S. patent application Ser. No. 11/624,811, filed Jan. 19, 2007 (now U.S. Patent Publication No. 2007/0170447) (attorney docket number P0961; 931-006 NP), the entirety of which is hereby incorporated by reference as if set forth in its entirety;

U.S. patent application Ser. No. 11/751,982, filed May 22, 2007 (now U.S. Patent Publication No. 2007/0274080) (attorney docket number P0916; 931-009 NP), the entirety of which is hereby incorporated by reference as if set forth in its entirety;

U.S. patent application Ser. No. 11/753,103, filed May 24, 2007 (now U.S. Patent Publication No. 2007/0280624) (attorney docket number P0918; 931-010 NP), the entirety of which is hereby incorporated by reference as if set forth in its entirety;

U.S. patent application Ser. No. 11/751,990, filed May 22. 2007 (now U.S. Patent Publication No. 2007/0274063) (attorney docket number P0917; 931-011 NP), the entirety of which is hereby incorporated by reference as if set forth in its entirety;

U.S. patent application Ser. No. 11/736,761, filed Apr. 18, 2007 (now U.S. Patent Publication No. 2007/0278934) (attorney docket number P0963; 931-012 NP), the entirety of which is hereby incorporated by reference as if set forth in its entirety;

U.S. patent application Ser. No. 11/936,163, filed Nov. 7, 2007 (now U.S. Patent Publication No. 2008/0106895) (attorney docket number P0928; 931-027 NP), the entirety of which is hereby incorporated by reference as if set forth in its entirety;

U.S. patent application Ser. No. 11/843,243, filed Aug. 22, 2007 (now U.S. Patent Publication No. 2008/0084685) (attorney docket number P0922; 931-034 NP), the entirety of which is hereby incorporated by reference as if set forth in its entirety;

U.S. Pat. No. 7,213,940 (attorney docket number P0936; 931-035 NP), issued on May 8, 2007, the entirety of which is hereby incorporated by reference as if set forth in its entirety;

U.S. patent application No. 60/868,134, filed on Dec. 1, 2006, entitled “LIGHTING DEVICE AND LIGHTING METHOD” (inventors: Antony Paul van de Ven and Gerald H. Negley; attorney docket number 931_{—}035 PRO), the entirety of which is hereby incorporated by reference as if set forth in its entirety;

U.S. patent application Ser. No. 11/948,021, filed on Nov. 30, 2007 (now U.S. Patent Publication No. 2008/0130285) (attorney docket number P0936 US2; 931-035 NP2), the entirety of which is hereby incorporated by reference as if set forth in its entirety;

U.S. patent application Ser. No. 12/475,850, filed on Jun. 1, 2009 (now U.S. Patent Publication No. 2009-0296384) (attorney docket number P1021; 931-035 CLP), the entirety of which is hereby incorporated by reference as if set forth in its entirety;

U.S. patent application Ser. No. 11/870,679, filed Oct. 11, 2007 (now U.S. Patent Publication No. 2008/0089053) (attorney docket number P0926; 931-041 NP), the entirety of which is hereby incorporated by reference as if set forth in its entirety;

U.S. patent application Ser. No. 12/117,148, filed May 8, 2008 (now U.S. Patent Publication No. 2008/0304261) (attorney docket number P0977; 931-072 NP), the entirety of which is hereby incorporated by reference as if set forth in its entirety; and

U.S. patent application Ser. No. 12/017,676, filed on Jan. 22, 2008 (now U.S. Patent Publication No. 2009/0108269) (attorney docket number P0982; 931-079 NP), the entirety of which is hereby incorporated by reference as if set forth in its entirety.

In some embodiments, a larger diffuse light source is preferable to a smaller source. In some embodiments, it may be very difficult to get even light distribution with a small light source (e.g., a point source). So, for example, an MXP (an “MXP” is a device marketed by Cree, Inc., in Durham, N.C., which provides an array of small LEDs in a device that is approximately three quarters of an inch in diameter) works better in some situations than an MC (an “MC”, also referred to as an “MCE”, is a component marketed by Cree, Inc., that includes four solid state light emitting dies, e.g., two BSY emitters and two red emitters (or three BSY emitters and one red emitter) or an XR-E (an “XR-E” is an LED marketed by Cree, Inc.). A larger diffuser or remote phosphor dome may be helpful in some embodiments. For example, a remote phosphor tube as described in U.S. patent application Ser. No. 12/273,216, filed Nov. 18, 2008, entitled “Semiconductor Light Emitting Apparatus Including Elongated Hollow Wavelength Conversion Tubes and Methods of Assembling Same” (inventors Hussell and Edmond) (now U.S. Patent Publication No. 2010-0124243) can be provided that extends up the center of the lamp. Also, an MXP with a diffuser, such as described in U.S. patent application Ser. No. 12/475,261, filed May 29, 2009, entitled “Light Source with Near Field Mixing” (inventors Negley and Keller) (now U.S. Patent Publication No. 2009-0283779), can be utilized as a light source.

Each of the heat dissipation elements can be of any of a variety of suitable shapes and sizes. For example, one or more of the heat dissipation elements can be in the shape of a vane or vanes, a mesh, a grid, a structure having a plurality of holes (e.g., a high surface area, low thickness structure having a plurality of holes extending through its thickness).

The two or more heat dissipation elements provided in any particular lighting device according to the present inventive subject matter can collectively be referred to as the “thermal management system” for the lighting device.

Any one or more regions of each of the heat dissipation elements provided in any thermal management system for a lighting device according to the present inventive subject matter can be integral with any or all of the other regions of the heat dissipation elements and/or can be attached to any or all of the other regions of the heat dissipation elements (e.g., by adhesive, bolts, screws, rivets, etc.). Furthermore, multiple heat dissipation elements may be provided as part of a unitary integral structure, as individual structures or as any suitable combination of unitary and combined structures.

Each of the at least two heat dissipation elements can independently be made from any suitable material or combination of materials, a wide variety of which will be apparent to persons skilled in the art. Any of the different heat dissipation elements can be made of differing materials or combinations of materials.

Representative examples of materials that can be employed in making heat dissipation elements include, for example, materials that inherently have high thermal conductivities, such as metals, metal alloys, ceramics, liquid crystal polymer, polyphenylene sulfide (PPS), thermoset bulk molded compound and polymers mixed with ceramic or metal or metalloid particles. One representative example of a suitable material is aluminum, e.g., extruded aluminum or die cast aluminum.

In some embodiments according to the present inventive subject matter, which can include or not include any of the features described elsewhere herein, at least a portion of at least one of the heat dissipation elements is transparent and/or reflective.

In embodiments in which at least a portion of one of the heat dissipation elements is transparent, the transparent portion(s) of the heat dissipation element(s) (or the transparent heat dissipation element(s)) can be made of any material (or combination of materials) (1) that is transparent or that can be made to become transparent, and (2) that is a good conductor of heat (e.g., having a heat conductivity of at least 1 W/m-K). Representative examples of suitable materials include aluminum nitride (AIN), silicon carbide (SiC), diamond, diamond-like carbon (DLC), any of a variety of transparent polymeric materials, any of a variety of ceramic materials and any of a variety of glass materials.

As noted above, the heat dissipation elements can take a wide variety of shapes, including shapes that, in embodiments in which at least a portion of one or more of the heat dissipation elements is transparent, would be expected to refract light in many complicated ways. With any of such lighting devices, particularly those that include one or more transparent heat dissipation element regions that refract light in complicated ways, persons of skill in the art are familiar with experimenting with and adjusting light refracting shapes so as to achieve desired light focusing, light directing, and/or light mixing properties, including mixing of light of differing hues.

In embodiments in which at least a portion of one or more of the heat dissipation elements is transparent, the transparent portion(s) can, if desired, include one or more optical features formed on its surface and/or within.

In embodiments in which at least a portion of one of the heat dissipation elements is reflective, the reflective portion(s) of the heat dissipation element(s) (or the reflective heat dissipation element(s)) can be made of any material (or combination of materials) (1) that is reflective or that can be made to become reflective, and (2) that is a good conductor of heat (e.g., having a heat conductivity of at least 1 W/m-K). The ability to reflect light can be provided or imparted in any suitable way, a variety of which are well known to persons of skill in the art. For example, the reflective portion(s) of the heat dissipation element(s) can comprise one or more material that is reflective (and/or specular, the term “reflective” being used herein to refer to reflective and optionally also specular), and/or that can be treated (e.g., polished) so as to be reflective, or can comprise one or more material that is non-reflective or only partially reflective and that is coated with, laminated to and/or otherwise attached to a reflective material. Persons of skill in the art are familiar with a variety of materials that are reflective, e.g., metals such as aluminum or silver, a dielectric stack of materials forming a Bragg Reflector, a dichroic reflector coating on glass (e.g., as described at www.lumascape.com/pdf/literature/C1087US.pdf), any other thin film reflectors, etc. Persons of skill in the art are familiar with a wide variety of materials which are suitable for making a non-reflective or partially reflective structure which can be coated with, laminated to or otherwise attached to a reflective material, including for instance plastic materials such as polyethylene, polypropylene, natural or synthetic rubbers, polycarbonate or polycarbonate copolymer, PAR (poly(4,4′-isopropylidenediphenylene terephthalate/isophthalate) copolymer), PEI (polyetherimide), and LCP (liquid crystal polymer). The reflective portion(s) of the heat dissipation element(s) can be formed out of highly reflective aluminum sheet with various coatings, including silver, from companies like Alanod (http://www.alanod.de/opencms/alanod/index.html_2063069299.html.), or the reflective portion(s) of the heat dissipation element(s) can be formed from glass. In cases where a lighting device according to the present inventive subject matter comprises more than one reflective portions (or more than one reflective heat dissipation elements), the respective reflective portions or reflective heat dissipation elements can be made of the same material, or any reflective portion(s) or reflective heat dissipation element(s) can be made of different materials.

Representative examples of suitable reflective elements are described in many patents, e.g., U.S. Pat. Nos. 6,945,672, 7,001,047, 7,131,760, 7,214,952 and 7,246,921 (the entireties of which are hereby incorporated by reference), each of which describes, among other things, reflective materials for use in making back-reflectors.

The reflective portions or reflective heat dissipation elements can be shaped and oriented relative to the one or more solid state light emitters such that some or all of the light from the solid state light emitter(s) will reflect once before exiting the lighting device, will reflect twice before exiting the lighting device (e.g., once off a first reflective heat dissipation element and once off a second reflective heat dissipation element, or twice off the same reflective heat dissipation element), or will reflect any other number of times before exiting the light device. This includes situations where some light from a solid state light emitter reflects a first number of times (e.g., only once) before exiting the lighting device and other light from the solid state light emitter reflects a second number of times (e.g., twice) before exiting the lighting device (and situations where any number of different parts of light from the solid state light emitter is reflected different numbers of times).

As noted above, the heat dissipation elements can take a wide variety of shapes, including shapes that, in embodiments in which at least a portion of one or more of the heat dissipation elements is reflective, would be expected to reflect light in many complicated ways. With any of such lighting devices, particularly those that include one or more reflective heat dissipation element regions that reflect light in complicated ways, persons of skill in the art are familiar with experimenting with and adjusting light reflecting shapes so as to achieve desired light focusing, light directing, and/or light mixing properties, including mixing of light of differing hues. Likewise, with lighting devices that include one or more reflective heat dissipation element regions that reflect light in complicated ways and one or more transparent heat dissipation element region that refract light in complicated ways, persons of skill in the art are familiar with experimenting with and adjusting light refracting shapes and light reflecting shapes so as to achieve desired light focusing, light directing, and/or light mixing properties, including mixing of light of differing hues.

Any portion(s) of one or more of the heat dissipation elements and/or one or more of the heat dissipation elements can be coated with a diffuse coating. Persons of skill in the art are familiar with a variety of materials that can be used to provide a diffuse coating (i.e., a coating that enhances diffusion of light), and any of such materials can be used.

Some embodiments according to the present inventive subject matter can further comprise one or more heat spreader. A heat spreader typically has a heat conductivity that is higher than the heat conductivity of the heat dissipation elements. For example, in some embodiments of the present inventive subject matter, which can include or not include any of the features described elsewhere herein, a heat spreader is provided in order for heat to be spread out into a larger surface area from which it can be dissipated through the heat dissipation elements.

Representative examples of materials out of which a heat spreader (if provided) can be made include copper, aluminum, diamond and DLC. A heat spreader (if provided) can be of any suitable shape.

With lighting devices that include light emitting diodes, the lower the thermal resistance from the light emitting diode(s) to the environment, the greater light that can be generated from a lighting device without exceeding the optimum maximum junction temperature (or, similar amounts of light can be generated with a lower light emitting diode junction temperature, possibly enabling longer light emitting diode life, and/or similar amounts of light can be generated with lighting devices of smaller overall size).

In some aspects of the present inventive subject matter, which can include or not include any of the features described elsewhere herein, there are provided solid state light emitter lamps that provide good heat dissipation (e.g., in some embodiments, sufficient that the solid state light emitter lamp can continue to provide at least 70% of its initial wall plug efficiency for at least 25,000 hours of operation of the lamp, and in some cases for at least 35,000 hours or 50,000 hours of operation of the lamp).

In some embodiments, lighting devices according to the present inventive subject matter are capable of dissipating over 30 W worth of heat without any active cooling elements.

If desired, some embodiments of lighting devices according to the present inventive subject matter can further comprise one or more active cooling elements, a wide variety of which are known to those skilled in the art, e.g., a fan, a piezoelectric device, a device comprising a magnetorestrictive material (e.g., MR, GMR, and/or FIMR materials), or any other active cooling element as described in U.S. patent application Ser. No. 12/683,886, filed on Jan. 7, 2010 (now U.S. Patent Publication No.______) (attorney docket number P1062 US4; 931-114 CIP2), the entirety of which is hereby incorporated by reference as if set forth in its entirety. In devices according to the present inventive subject matter that include one or more active cooling elements, typically only enough air to break the boundary layer is required to induce temperature drops of 10 to 15 degrees C. (hence, in such cases, strong “breezes” or a large fluid flow rate (large CFM) are typically not required).

The heat dissipation elements may be spaced to allow air to pass between the heat dissipation elements and to decouple (completely or to a significant degree) the heat dissipation elements thermally. The number and shape(s) of the heat dissipation elements can be selected based on the specific application (e.g., number of solid state light emitters, desired size and shape of the overall lighting device, etc.).

The one or more solid state light emitters can be positioned in any suitable way. In some embodiments, for example, the solid state light emitters can be mounted on one or more of the heat dissipation elements (e.g., they can be distributed among the heat dissipation elements), or may be placed in a central location and thermally coupled to the heat dissipation elements (or one or more solid state light emitters can be mounted on the heat dissipation elements and one or more solid state light emitters may be placed in a central location).

The arrangement of the solid state light emitter or solid state light emitters, and/or the desired shape of the overall lighting device, and/or the desired function of the lighting device can be considered in designing the shape of the heat dissipation elements and/or in positioning the heat dissipation elements.

The lighting devices according to the present inventive subject matter can be any suitable shape and size. For example, a lighting device according to the present inventive subject matter can fit within the envelope for any conventional lighting device, e.g., A lamps (i.e., which meets the dimensional constraints for a lamp to be characterized as an A lamp), B-10 lamps, BR lamps, C-7 lamps, C-15 lamps, ER lamps, F lamps, G lamps, K lamps, MB lamps, MR lamps, PAR lamps, PS lamps, R lamps, S lamps, S-11 lamps, T lamps, Linestra 2-base lamps, AR lamps, ED lamps, E lamps, BT lamps, Linear fluorescent lamps, U-shape fluorescent lamps, circline fluorescent lamps, single twin tube compact fluorescent lamps, double twin tube compact fluorescent lamps, triple twin tube compact fluorescent lamps, A-line compact fluorescent lamps, screw twist compact fluorescent lamps, globe screw base compact fluorescent lamps, reflector screw base compact fluorescent lamps, etc., or any other conventional lighting device, or any other shape and size.

The expression “after thermal equilibrium has been reached” refers to supplying current to one or more light sources in a lighting device to allow the light source(s) and other surrounding structures to heat up to (or near to) a temperature to which they will typically be heated when the lighting device is illuminated. The particular duration that current should be supplied will depend on the particular configuration of the lighting device. For example, the greater the thermal mass, the longer it will take for the light source(s) to approach their thermal equilibrium operating temperature. While a specific time for operating the lighting device prior to reaching thermal equilibrium may be lighting device specific, in some embodiments, durations of from about 1 to about 60 minutes or more and, in specific embodiments, about 30 minutes, may be used. In some instances, thermal equilibrium is reached when the temperature of the light source (or each of the light sources) does not vary substantially (e.g., more than 2 degrees C.) without a change in ambient or operating conditions.

In many situations, the lifetime of light sources, e.g., solid state light emitters, can be correlated to a thermal equilibrium temperature (e.g., junction temperatures of solid state light emitters). The correlation between lifetime and junction temperature may differ based on the manufacturer (e.g., in the case of solid state light emitters, Cree, Inc., Philips-Lumileds, Nichia, etc). The lifetimes are typically rated as thousands of hours at a particular temperature (junction temperature in the case of solid state light emitters). Thus, in particular embodiments, the component or components of the thermal management system of the lighting device is/are selected so as to extract heat from the light source(s) and dissipate the extracted heat to a surrounding environment at such a rate that a temperature is maintained at or below a particular temperature (e.g., to maintain a junction temperature of a solid state light emitter at or below a 25,000 hour rated lifetime junction temperature for the solid state light source in a 25° C. surrounding environment, in some embodiments, at or below a 35,000 hour rated lifetime junction temperature, in further embodiments, at or below a 50,000 hour rated lifetime junction temperature, or other hour values, or in other embodiments, analogous hour ratings where the surrounding temperature is 35° C. (or any other value).

Heat transfer from one structure or region to another can be enhanced (i.e., thermal resistivity can be reduced or minimized) using any suitable material or structure for doing so, a variety of which are known to persons of skill in the art, e.g., by means of chemical or physical bonding and/or by interposing a heat transfer aid such as a thermal pad, thermal grease, graphite sheets, etc.

In some embodiments according to the present inventive subject matter, which can include or not include any of the features described elsewhere herein, a portion (or portions) of any of the one or more heat dissipation elements (or other element or elements) can comprise one or more thalami transfer region(s) that has/have an elevated heat conductivity (e.g., higher than the rest of that heat dissipation element or other element) and/or one or more elements of higher heat conducting capability (e.g., one or more wires, bars, layers, particles, regions, heat pipes and/or slivers) positioned within the heat dissipation element(s). Any such thermal transfer region(s) or elements of higher heat conducting capability, if included, can also function as one or more electrical terminals for carrying electricity and/or as one or more pathways for carrying electricity, e.g., to the one or more solid state light emitters. A thermal transfer region (or regions) can be made of any suitable material, and can be of any suitable shape. Use of materials having higher heat conductivity in making the thermal transfer region(s) generally provides greater heat transfer, and use of thermal transfer region(s) of larger surface area and/or cross-sectional area generally provides greater heat transfer. Representative examples of materials that can be used to make the thermal transfer region(s), if provided, include metals, diamond, DLC, etc. Representative examples of shapes in which the thermal transfer region(s), if provided, can be formed include bars, slivers, slices, crossbars, wires and/or wire patterns.

Some embodiments in accordance with the present inventive subject matter (which can include or not include any of the features described elsewhere herein) include one or more lenses or diffusers. Persons of skill in the art are familiar with a wide variety of lenses and diffusers, can readily envision a variety of materials out of which a lens or a diffuser can be made, and are familiar with and/or can envision a wide variety of shapes that lenses and diffusers can be. Any of such materials and/or shapes can be employed in a lens and/or a diffuser in an embodiment that includes a lens and/or a diffuser. As will be understood by persons skilled in the art, a lens or a diffuser in a lighting device according to the present inventive subject matter can be selected to have any desired effect on incident light (or no effect), such as focusing, diffusing, etc.

In embodiments in accordance with the present inventive subject matter that include a diffuser (or plural diffusers), the diffuser (or diffusers) can be positioned in any suitable location and orientation. In some embodiments, which can include or not include any of the features described elsewhere herein, a diffuser can be provided over a top or any other part of the lighting device, and the diffuser can comprise one or more luminescent material (e.g., in particulate form) spread throughout a portion of the diffuser or an entirety of the diffuser.

In embodiments in accordance with the present inventive subject matter that include a lens (or plural lenses), the lens (or lenses) can be positioned in any suitable location and orientation.

In addition, one or more scattering elements (e.g., layers) can optionally be included in the lighting devices according to this aspect of the present inventive subject matter. The scattering element can be included in a lumiphor, and/or a separate scattering element can be provided. A wide variety of separate scattering elements and combined luminescent and scattering elements are well known to those of skill in the art, and any such elements can be employed in the lighting devices of the present inventive subject matter.

The lighting devices of the present inventive subject matter can be arranged, mounted and supplied with electricity in any desired manner, and can be mounted on any suitable housing or fixture. Skilled artisans are familiar with a wide variety of arrangements, mounting schemes, power supplying apparatuses, housings and fixtures, and any such arrangements, schemes, apparatuses, housings and fixtures can be employed in connection with the present inventive subject matter.

Representative examples of arrangements of lighting devices, schemes for mounting lighting devices, apparatus for supplying electricity to lighting devices, housings for lighting devices and fixtures for lighting devices, all of which are suitable for the lighting devices of the present inventive subject matter, are described in

U.S. patent application Ser. No. 11/613,692, filed Dec. 20, 2006 (now U.S. Patent Publication No. 2007/0139923) (attorney docket number P0956; 931-002), the entirety of which is hereby incorporated by reference as if set forth in its entirety;

U.S. patent application Ser. No. 11/743,754, filed May 3, 2007 (now U.S. Patent Publication No. 2007/0263393) (attorney docket number P0957; 931-008), the entirety of which is hereby incorporated by reference as if set forth in its entirety;

U.S. patent application Ser. No. 11/755,153, filed May 30, 2007 (now U.S. Patent Publication No. 2007/0279903) (attorney docket number P0920; 931-017), the entirety of which is hereby incorporated by reference as if set forth in its entirety;

U.S. patent application Ser. No. 11/856,421, filed Sep. 17, 2007 (now U.S. Patent Publication No. 2008/0084700) (attorney docket number P0924; 931-019), the entirety of which is hereby incorporated by reference as if set forth in its entirety;

U.S. patent application Ser. No. 11/859,048, filed Sep. 21, 2007 (now U.S. Patent Publication No. 2008/0084701) (attorney docket number P0925; 931-021), the entirety of which is hereby incorporated by reference as if set forth in its entirety;

U.S. patent application Ser. No. 11/939,047, filed Nov. 13, 2007 (now U.S. Patent Publication No. 2008/0112183) (attorney docket number P0929; 931-026), the entirety of which is hereby incorporated by reference as if set forth in its entirety;

U.S. patent application Ser. No. 11/939,052, filed Nov. 13, 2007 (now U.S. Patent Publication No. 2008/0112168) (attorney docket number P0930; 931-036), the entirety of which is hereby incorporated by reference as if set forth in its entirety;

U.S. patent application Ser. No. 11/939,059, filed Nov. 13, 2007 (now U.S. Patent Publication No. 2008/0112170) (attorney docket number P0931; 931-037), the entirety of which is hereby incorporated by reference as if set forth in its entirety;

U.S. patent application Ser. No. 11/877,038, filed Oct. 23, 2007 (now U.S. Patent Publication No. 2008/0106907) (attorney docket number P0927; 931-038), the entirety of which is hereby incorporated by reference as if set forth in its entirety;

U.S. patent application Ser. No. 60/861,901, filed on Nov. 30, 2006, entitled “LED DOWNLIGHT WITH ACCESSORY ATTACHMENT” (inventors: Gary David Trott, Paul Kenneth Pickard and Ed Adams; attorney docket number 931_{—}044 PRO), the entirety of which is hereby incorporated by reference as if set forth in its entirety;

U.S. patent application Ser. No. 11/948,041, filed Nov. 30, 2007 (now U.S. Patent Publication No. 2008/0137347) (attorney docket number P0934; 931-055), the entirety of which is hereby incorporated by reference as if set forth in its entirety;

U.S. patent application Ser. No. 12/114,994, filed May 5, 2008 (now U.S. Patent Publication No. 2008/0304269) (attorney docket number P0943; 931-069), the entirety of which is hereby incorporated by reference as if set forth in its entirety;

U.S. patent application Ser. No. 12/116,341, filed May 7, 2008 (now U.S. Patent Publication No. 2008/0278952) (attorney docket number P0944; 931-071), the entirety of which is hereby incorporated by reference as if set forth in its entirety;

U.S. patent application Ser. No. 12/277,745, filed on Nov. 25, 2008 (now U.S. Patent Publication No. 2009-0161356) (attorney docket number P0983; 931-080 NP), the entirety of which is hereby incorporated by reference as if set forth in its entirety;

U.S. patent application Ser. No. 12/116,346, filed May 7, 2008 (now U.S. Patent Publication No. 2008/0278950) (attorney docket number P0988; 931-086), the entirety of which is hereby incorporated by reference as if set forth in its entirety;

U.S. patent application Ser. No. 12/116,348, filed on May 7, 2008 (now U.S. Patent Publication No. 2008/0278957) (attorney docket number P1006; 931-088), the entirety of which is hereby incorporated by reference as if set forth in its entirety;

U.S. patent application Ser. No. 12/467,467, filed on May 18, 2009 (now U.S. Patent Publication No. 2010/0290222) (attorney docket number P1005; 931-091 NP), the entirety of which is hereby incorporated by reference as if set forth in its entirety;

U.S. patent application Ser. No. 12/512,653, filed on Jul. 30, 2009 (now U.S. Patent Publication No. 2010-0102697) (attorney docket number P1010; 931-092 NP), the entirety of which is hereby incorporated by reference as if set forth in its entirety;

U.S. patent application Ser. No. 12/465,203 5/13/09, filed on May 13, 2009 (now U.S. Patent Publication No. 2010/0290208) (attorney docket number P1027; 931-094 NP), the entirety of which is hereby incorporated by reference as if set forth in its entirety;

U.S. patent application Ser. No. 12/469,819, filed on May 21, 2009 (now U.S. Patent Publication No. 2010-0102199) (attorney docket number P1029; 931-095 NP), the entirety of which is hereby incorporated by reference as if set forth in its entirety;

U.S. patent application Ser. No. 12/469,828, filed on May 21, 2009 (now U.S. Patent Publication No. 2010-0103678) (attorney docket number P1038; 931-096 NP), the entirety of which is hereby incorporated by reference as if set forth in its entirety;

U.S. patent application Ser. No. 12/566,936, filed on Sep. 25, 2009 (now U.S. Patent Publication No.______) (attorney docket number P1144; 931-106 NP), the entirety of which is hereby incorporated by reference as if set forth in its entirety;

U.S. patent application Ser. No. 12/566,857, filed on Sep. 25, 2009 (now U.S. Patent Publication No.______) (attorney docket number P1181; 931-110 NP), the entirety of which is hereby incorporated by reference as if set forth in its entirety; and

U.S. patent application Ser. No. 12/566,861, filed on Sep. 25, 2009 (now U.S. Patent Publication No.______) (attorney docket number P1177; 931-113 NP), the entirety of which is hereby incorporated by reference as if set forth in its entirety.

In some embodiments in accordance with the present inventive subject matter, the lighting device can emit light in all directions, while in other embodiments, the lighting device can emit light in fewer than all directions (as a result of the shape of the lighting device and/or the nature of the lighting device, and/or as a result of a shade positioned relative to the lighting device, and/or as a result of some other angular control of the light emanating from the lighting device).

The lighting devices according to the present inventive subject matter can be incorporated in devices designed so as to serve any of a variety of functions (e.g., as a flood light, as a spotlight, as a downlight, etc.), for residential, commercial or other applications.

Any desired circuitry (including any desired electronic components) can be employed in order to supply energy to the one or more solid state light emitters in the lighting devices according to the present inventive subject matter. Representative examples of circuitry which may be used are described in:

U.S. patent application Ser. No. 11/626,483, filed Jan. 24, 2007 (now U.S. Patent Publication No. 2007/0171145) (attorney docket number P0962; 931-007 NP), the entirety of which is hereby incorporated by reference as if set forth in its entirety;

U.S. patent application Ser. No. 11/755,162, filed May 30, 2007 (now U.S. Patent Publication No. 2007/0279440) (attorney docket number P0921; 931-018 NP), the entirety of which is hereby incorporated by reference as if set forth in its entirety;

U.S. patent application Ser. No. 11/854,744, filed Sep. 13, 2007 (now U.S. Patent Publication No. 2008/0088248) (attorney docket number P0923; 931-020 NP), the entirety of which is hereby incorporated by reference as if set forth in its entirety;

U.S. patent application Ser. No. 12/117,280, filed May 8, 2008 (now U.S. Patent Publication No. 2008/0309255) (attorney docket number P0979; 931-076 NP), the entirety of which is hereby incorporated by reference as if set forth in its entirety;

U.S. patent application Ser. No. 12/328,144, filed Dec. 4, 2008 (now U.S. Patent Publication No. 2009/0184666) (attorney docket number P0987; 931-085 NP), the entirety of which is hereby incorporated by reference as if set forth in its entirety;

U.S. patent application Ser. No. 12/328,115, filed on Dec. 4, 2008 (now U.S. Patent Publication No. 2009-0184662)(attorney docket number P1039; 931-097 NP), the entirety of which is hereby incorporated by reference as if set forth in its entirety;

U.S. patent application Ser. No. 12/566,142, filed on Sep. 24, 2009, entitled “Solid State Lighting Apparatus With Configurable Shunts” (now U.S. Patent Publication No.) ______(attorney docket number P1091; 5308-1091), the entirety of which is hereby incorporated by reference as if set forth in its entirety; and

U.S. patent application Ser. No. 12/566,195, filed on Sep. 24, 2009, entitled “Solid State Lighting Apparatus With Controllable Bypass Circuits And Methods Of Operation Thereof”, now U.S. Patent Publication No.______(attorney docket number P1128; 5308-1128), the entirety of which is hereby incorporated by reference as if set forth in its entirety.

The lighting devices according to the present inventive subject matter can further comprise a power supply and/or a driver. For example, solid state lighting systems have been developed that include a power supply that receives the AC line voltage and converts that voltage to a voltage (e.g., to DC and to a different voltage value) and/or current suitable for driving solid state light emitters. Typical power supplies for light emitting diode light sources include linear current regulated supplies and/or pulse width modulated current and/or voltage regulated supplies.

A driver can comprise one or more electrical components employed in driving one or more light source, e.g., running one or more light source intermittently and/or adjusting the current supplied to one or more light sources in response to a user command, a detected change in intensity or color of light output, a detected change in an ambient characteristic such as temperature or background light, etc., and/or a signal contained in the input power (e.g., a dimming signal in AC power supplied to the lighting device).

A driver can include any of a variety of components, for example, (1) one or more electrical components employed in converting electrical power (e.g., from AC to DC), (2) one or more electrical components employed in driving one or more light source, e.g., running one or more light source intermittently and/or adjusting the current supplied to one or more light sources in response to a user command, a detected change in intensity or color of light output, a detected change in an ambient characteristic such as temperature or background light, etc., and/or a signal contained in the input power (e.g., a dimming signal in AC power supplied to the lighting device), etc., (3) one or more circuit boards (e.g., a metal core circuit board) for supporting any electrical components, (4) one or more wires connecting any components (e.g., connecting an Edison socket to a circuit board), etc.

Many different techniques have been described for driving solid state light sources in many different applications, including, for example, those described in U.S. Pat. No. 3,755,697 to Miller, U.S. Pat. No. 5,345,167 to Hasegawa et al, U.S. Pat. No. 5,736,881 to Ortiz, U.S. Pat. No. 6,150,771 to Perry, U.S. Pat. No. 6,329,760 to Bebenroth, U.S. Pat. No. 6,873,203 to Latham, II et al, U.S. Pat. No. 5,151,679 to Dimmick, U.S. Pat. No. 4,717,868 to Peterson, U.S. Pat. No. 5,175,528 to Choi et al, U.S. Pat. No.

3,787,752 to Delay, U.S. Pat. No. 5,844,377 to Anderson et al, U.S. Pat. No. 6,285,139 to Ghanem, U.S. Pat. No. 6,161,910 to Reisenauer et al, U.S. Pat. No. 4,090,189 to Fisler, U.S. Pat. No. 6,636,003 to Rahm et al, U.S. Pat. No. 7,071,762 to Xu et al, U.S. Pat. No. 6,400,101 to Biebl et al, U.S. Pat. No. 6,586,890 to Min et al, U.S. Pat. No. 6,222,172 to Fossum et al, U.S. Pat. No. 5,912,568 to Kiley, U.S. Pat. No. 6,836,081 to Swanson et al, U.S. Pat. No. 6,987,787 to Mick, U.S. Pat. No. 7,119,498 to Baldwin et al, U.S. Pat. No. 6,747,420 to Barth et al, U.S. Pat. No. 6,808,287 to Lebens et al, U.S. Pat. No. 6,841,947 to Berg-johansen, U.S. Pat. No. 7,202,608 to Robinson et al, U.S. Pat. No. 6,995,518, U.S. Pat. No. 6,724,376, U.S. Pat. No. 7,180,487 to Kamikawa et al, U.S. Pat. No. 6,614,358 to Hutchison et al, U.S. Pat. No. 6,362,578 to Swanson et al, U.S. Pat. No. 5,661,645 to Hochstein, U.S. Pat. No. 6,528,954 to Lys et al, U.S. Pat. No. 6,340,868 to Lys et al, U.S. Pat. No. 7,038,399 to Lys et al, U.S. Pat. No. 6,577,072 to Saito et al, and U.S. Pat. No. 6,388,393 to Illingworth.

Various types of electrical connectors are well known to those skilled in the art, and any of such electrical connectors can be used in the lighting devices according to the present inventive subject matter. Representative examples of suitable types of electrical connectors include Edison plugs (which are receivable in Edison sockets) and GU24 pins (which are receivable in GU24 sockets).

The electrical connector, when included, can be electrically connected to the lighting device in any suitable way. A representative example of a way to electrically connect a lighting device to an electrical connector is to connect a first portion of a flexible wire to the electrical connector and to connect a second portion of the flexible wire to a circuit board (e.g., a metal core circuit board) on which the first solid state light emitter (or a plurality of solid state light emitters) is mounted.

Some embodiments in accordance with the present inventive subject matter (which can include or not include any of the features described elsewhere herein) can comprise a power line that can be connected to a source of power (such as a branch circuit, a battery, a photovoltaic collector, etc.) and that can supply power to an electrical connector (or directly to the lighting device). Persons of skill in the art are familiar with, and have ready access to, a variety of structures that can be used as a power line. A power line can be any structure that can carry electrical energy and supply it to an electrical connector on a fixture element and/or to a lighting device according to the present inventive subject matter.

Energy can be supplied to the lighting devices according to the present inventive subject matter from any source or combination of sources, for example, the grid (e.g., line voltage), one or more batteries, one or more photovoltaic energy collection device (i.e., a device that includes one or more photovoltaic cells that convert energy from the sun into electrical energy), one or more windmills, etc.

The various components in the lighting devices can be mounted in any suitable way.

For example, in some embodiments, one or more solid state light emitters can be mounted on a first circuit board (a “solid state light emitter circuit board”) and electronic circuitry that can convert AC line voltage into DC voltage suitable for being supplied to the one or more solid state light emitters can be mounted on a second circuit board (a “driver circuit board”), whereby line voltage is supplied to the electrical connector and passed along to the driver circuit board, the line voltage is converted to DC voltage suitable for being supplied to solid state light emitters in the driver circuit board, and the DC voltage is passed along to the solid state light emitter circuit board where it is then supplied to the one or more solid state light emitters.

In general, light of any number of colors can be mixed by the lighting devices according to the present inventive subject matter. Representative examples of blending of light colors are described in:

U.S. patent application Ser. No. 11/613,714, filed Dec. 20, 2006 (now U.S. Patent Publication No. 2007/0139920) (attorney docket number P0959; 931-004 NP), the entirety of which is hereby incorporated by reference as if set forth in its entirety;

U.S. patent application Ser. No. 11/613,733, filed Dec. 20, 2006 (now U.S. Patent Publication No. 2007/0137074) (attorney docket number P0960; 931-005 NP) the entirety of which is hereby incorporated by reference as if set forth in its entirety;

U.S. patent application Ser. No. 11/736,761, filed Apr. 18, 2007 (now U.S. Patent Publication No. 2007/0278934) (attorney docket number P0963; 931-012 NP), the entirety of which is hereby incorporated by reference as if set forth in its entirety;

U.S. patent application Ser. No. 11/736,799, filed Apr. 18, 2007 (now U.S. Patent Publication No. 2007/0267983) (attorney docket number P0964; 931-013 NP), the entirety of which is hereby incorporated by reference as if set forth in its entirety;

U.S. patent application Ser. No. 11/737,321, filed Apr. 19, 2007 (now U.S. Patent Publication No. 2007/0278503) (attorney docket number P0965; 931-014 NP), the entirety of which is hereby incorporated by reference as if set forth in its entirety;

U.S. patent application Ser. No. 11/936,163, filed Nov. 7, 2007 (now U.S. Patent Publication No. 2008/0106895) (attorney docket number P0928; 931-027 NP), the entirety of which is hereby incorporated by reference as if set forth in its entirety;

U.S. patent application Ser. No. 12/117,122, filed May 8, 2008 (now U.S. Patent Publication No. 2008/0304260) (attorney docket number P0945; 931-031 NP), the entirety of which is hereby incorporated by reference as if set forth in its entirety;

U.S. patent application Ser. No. 12/117,131, filed May 8, 2008 (now U.S. Patent Publication No. 2008/0278940) (attorney docket number P0946; 931-032 NP), the entirety of which is hereby incorporated by reference as if set forth in its entirety;

U.S. patent application Ser. No. 12/117,136, filed May 8, 2008 (now U.S. Patent Publication No. 2008/0278928) (attorney docket number P0947; 931-033 NP), the entirety of which is hereby incorporated by reference as if set forth in its entirety;

U.S. Patent No. 7,213,940 (attorney docket number P0936; 931-035 NP), issued on May 8, 2007, the entirety of which is hereby incorporated by reference as if set forth in its entirety;

U.S. patent application Ser. No. 60/868,134, filed on Dec. 1, 2006, entitled “LIGHTING DEVICE AND LIGHTING METHOD” (inventors: Antony Paul van de Ven and Gerald H. Negley; attorney docket number 931_{—}035 PRO), the entirety of which is hereby incorporated by reference as if set forth in its entirety;

U.S. patent application Ser. No. 11/948,021, filed on Nov. 30, 2007 (now U.S. Patent Publication No. 2008/0130285) (attorney docket number P0936 US2; 931-035 NP2), the entirety of which is hereby incorporated by reference as if set forth in its entirety;

U.S. patent application Ser. No. 12/475,850, filed on Jun. 1, 2009 (now U.S. Patent Publication No. 2009-0296384) (attorney docket number P1021; 931-035 CIP), the entirety of which is hereby incorporated by reference as if set forth in its entirety;

U.S. patent application Ser. No. 12/248,220, filed on Oct. 9, 2008 (now U.S. Patent Publication No. 2009/0184616) (attorney docket number P0967; 931-040 NP), the entirety of which is hereby incorporated by reference as if set forth in its entirety;

U.S. patent application Ser. No. 11/951,626, filed Dec. 6, 2007 (now U.S. Patent Publication No. 2008/0136313) (attorney docket number P0939; 931-053 NP), the entirety of which is hereby incorporated by reference as if set forth in its entirety;

U.S. patent application Ser. No. 12/035,604, filed on Feb. 22, 2008 (now U.S. Patent Publication No. 2008/0259589) (attorney docket number P0942; 931-057 NP), the entirety of which is hereby incorporated by reference as if set forth in its entirety;

U.S. patent application Ser. No. 12/117,148, filed May 8, 2008 (now U.S. Patent Publication No. 2008/0304261) (attorney docket number P0977; 931-072 NP), the entirety of which is hereby incorporated by reference as if set forth in its entirety;

U.S. patent application Ser. No. 60/990,435, filed on Nov. 27, 2007, entitled “WARM WHITE ILLUMINATION WITH HIGH CRI AND HIGH EFFICACY” (inventors: Antony Paul van de Ven and Gerald H. Negley; attorney docket no. 931_{—}081 PRO), the entirety of which is hereby incorporated by reference as if set forth in its entirety; and

U.S. patent application Ser. No. 12/535,319, filed on Aug. 4, 2009 (now U.S. Patent Publication No.______) (attorney docket number P0997; 931-089 NP), the entirety of which is hereby incorporated by reference as if set forth in its entirety.

The solid state light emitter(s) (and any luminescent material) can be arranged in any desired pattern.

Some embodiments according to the present inventive subject matter can include solid state light emitters that emit light of a first hue (e.g., light within the BSY range (defined below) and solid state light emitters that emit light of a second hue (e.g., that is not within the BSY range, such as red or reddish or reddish orange or orangish, or orange light), where each of the solid state light emitters that emit light that is not BSY light is surrounded by five or six solid state light emitters that emit BSY light.

The expression “BSY”, as used herein, refers to light having x, y color coordinates which define a point which is within (1) an area on a 1931 CIF, Chromaticity Diagram enclosed by first, second, third, fourth and fifth line segments, said first line segment connecting a first point to a second point, said second line segment connecting said second point to a third point, said third line segment connecting said third point to a fourth point, said fourth line segment connecting said fourth point to a fifth point, and said fifth line segment connecting said fifth point to said first point, said first point having x, y coordinates of 0.32, 0.40, said second point having x, y coordinates of 0.36, 0.48, said third point having x, y coordinates of 0.43, 0.45, said fourth point having x, y coordinates of 0.42, 0.42, and said fifth point having x, y coordinates of 0.36, 0.38, and/or (2) an area on a 1931 CIE Chromaticity Diagram enclosed by first, second, third, fourth and fifth line segments, the first line segment connecting a first point to a second point, the second line segment connecting the second point to a third point, the third line segment connecting the third point to a fourth point, the fourth line segment connecting the fourth point to a fifth point, and the fifth line segment connecting the fifth point to the first point, the first point having x, y coordinates of 0.29, 0.36, the second point having x, y coordinates of 0.32, 0.35, the third point having x, y coordinates of 0.41, 0.43, the fourth point having x, y coordinates of 0.44, 0.49, and the fifth point having x, y coordinates of 0.38, 0.53).

In some embodiments, solid state light emitters (including, e.g., a first group that emit light of a first hue (e.g., red, reddish, reddish-orange, orangish or orange light), and a second group that emit light of a second hue (e.g., BSY)) may be arranged pursuant to a guideline described below in paragraphs (1)-(5), or any combination of two or more thereof, to promote mixing of light from light sources emitting different colors of light:

(1) an array that has groups of first and second solid state light emitters with the first group of solid state light emitters arranged so that no two of the first group solid state light emitters are directly next to one another in the array;

(2) an array that comprises a first group of solid state light emitters and one or more additional groups of solid state light emitters, the first group of solid state light emitters being arranged so that at least three solid state light emitters from the one or more additional groups is adjacent each of the solid state light emitters in the first group;

(3) an array is mounted on a submount, and the array comprises a first group of solid state light emitters and one or more additional groups of solid state light emitters, and (c) the array is arranged so that less than fifty percent (50%), or as few as possible, of the solid state light emitters in the first group of solid state light emitters are on the perimeter of the array;

(4) an array comprises a first group of solid state light emitters and one or more additional groups of solid state light emitters, and the first group of solid state light emitters is arranged so that no two solid state light emitters from the first group are directly next to one another in the array, and so that at least three solid state light emitters from the one or more additional groups is adjacent each of the solid state light emitters in the first group; and/or

(5) an array is arranged so that no two solid state light emitters from the first group are directly next to one another in the array, fewer than fifty percent (50%) of the solid state light emitters in the first group of solid state light emitters are on the perimeter of the array, and at least three solid state light emitters from the one or more additional groups is adjacent each of the solid state light emitters in the first group.

It is understood that arrays can also be arranged other ways, and can have additional features, that promote color mixing. In some embodiments, solid state light emitters can be arranged so that they are tightly packed, which can further promote natural color mixing. The lighting devices can also comprise different diffusers and reflectors to promote color mixing in the near field and in the far field.

The lighting devices according to the present inventive subject matter can further comprise elements that help to ensure that the perceived color (including color temperature) of the light exiting the lighting device is accurate (e.g., within a specific tolerance). A wide variety of such elements and combinations of elements are known, and any of them can be employed in the lighting devices according to the present inventive subject matter. For instance, representative examples of such elements and combinations of elements are described in:

U.S. patent application Ser. No. 11/755,149, filed May 30, 2007 (now U.S. Patent Publication No. 2007/0278974) (attorney docket number P0919; 931-015 NP), the entirety of which is hereby incorporated by reference as if set forth in its entirety;

U.S. patent application Ser. No. 12/117,280, filed May 8, 2008 (now U.S. Patent Publication No. 2008/0309255) (attorney docket number P0979; 931-076 NP), the entirety of which is hereby incorporated by reference as if set forth in its entirety;

U.S. patent application Ser. No. 12/257,804, filed on Oct. 24, 2008 (now U.S. Patent Publication No. 2009/0160363) (attorney docket number P0985; 931-082 NP), the entirety of which is hereby incorporated by reference as if set forth in its entirety;

U.S. patent application Ser. No. 12/469,819, filed on May 21, 2009 (now U.S. Patent Publication No. 2010-0102199) (attorney docket number P1029; 931-095 NP), the entirety of which is hereby incorporated by reference as if set forth in its entirety;

Some embodiments of the present inventive subject matter, which can include or not include any of the features described elsewhere herein, can comprise one or more controllers configured to control a ratio of light emitted by at least a first light emitter and light emitted by at least a second light emitter such that a combination of the light is of a desired color point.

A controller may be a digital controller, an analog controller or a combination of digital and analog. For example, the controller may be an application specific integrated circuit (ASIC), a microprocessor, a microcontroller, a collection of discrete components or combinations thereof. In some embodiments, the controller may be programmed to control the lighting devices. In some embodiments, control of the lighting devices may be provided by the circuit design of the controller and is, therefore, fixed at the time of manufacture. In still further embodiments, aspects of the controller circuit, such as reference voltages, resistance values or the like, may be set at the time of manufacture so as to allow adjustment of the control of the lighting devices without the need for programming or control code.

Representative examples of suitable controllers are described in:

U.S. patent application Ser. No. 11/755,149, filed May 30, 2007 (now U.S. Patent Publication No. 2007/0278974), the entirety of which is hereby incorporated by reference as if set forth in its entirety;

U.S. patent application Ser. No. 12/117,280, filed May 8, 2008 (now U.S. Patent Publication No. 2008/0309255), the entirety of which is hereby incorporated by reference as if set forth in its entirety; and

U.S. patent application Ser. No. 12/257,804, filed on Oct. 24, 2008 (now U.S. Patent Publication No. 2009/0160363), the entirety of which is hereby incorporated by reference as if set forth in its entirety.

Some embodiments in accordance with the present inventive subject matter (which can include or not include any of the features described elsewhere herein) can employ at least one temperature sensor. Persons of skill in the art are familiar with, and have ready access to, a variety of temperature sensors (e.g., thermistors), and any of such temperature sensors can be employed in embodiments in accordance with the present inventive subject matter. Temperature sensors can be used for a variety of purposes, e.g., to provide feedback information to current adjusters, as described in U.S. patent application Ser. No. 12/117,280, filed May 8, 2008 (now U.S. Patent Publication No. 2008/0309255), the entirety of which is hereby incorporated by reference as if set forth in its entirety.

In some embodiments according to the present inventive subject matter, the lighting device emits at least 600 lumens, and in some embodiments at least 750 lumens, at least 900 lumens, at least 1000 lumens, at least 1100 lumens, at least 1200 lumens, at least 1300 lumens, at least 1400 lumens, at least 1500 lumens, at least 1600 lumens, at least 1700 lumens, at least 1800 lumens (or in some cases at least even higher lumen outputs), and/or CRI Ra of at least 70, and in some embodiments at least 80, at least 85, at least 90 or at least 95) when the lighting device is energized (e.g., by supplying line voltage to the lighting device).

In some aspects of the present inventive subject matter, which can include or not include any of the features described elsewhere herein, there are provided lighting devices that emit light in a desired range of directions, e.g., substantially omnidirectionally or in some other desired pattern.

The lighting devices according to the present inventive subject matter can direct light in generally any desired range of directions. For instance, in some embodiments, the lighting device can direct light substantially omnidirectionally (i.e., substantially 100% of all directions extending from a center of the lighting device), i.e., within a volume defined by a two-dimensional shape in an x, y plane that encompasses rays extending from 0 degrees to 180 degrees relative to the y axis (i.e., 0 degrees extending from the origin along the positive y axis, 180 degrees extending from the origin along the negative y axis), the two-dimensional shape being rotated 360 degrees about the y axis (in some cases, the y axis can be a vertical axis of the lighting device). In some embodiments, the lighting device emits light substantially in all directions within a volume defined by a two-dimensional shape in an x, y plane that encompasses rays extending from 0 degrees to 150 degrees relative to the y axis (extending along a vertical axis of the lighting device), the two-dimensional shape being rotated 360 degrees about the y axis. In some embodiments, the lighting device emits light substantially in all directions within a volume defined by a two-dimensional shape in an x, y plane that encompasses rays extending from 0 degrees to 120 degrees relative to the y axis (extending along a vertical axis of the lighting device), the two-dimensional shape being rotated 360 degrees about the y axis. In some embodiments, the lighting device emits light substantially in all directions within a volume defined by a two-dimensional shape in an x, y plane that encompasses rays extending from 0 degrees to 90 degrees relative to the y axis (extending along a vertical axis of the lighting device), the two-dimensional shape being rotated 360 degrees about the y axis (i.e., a hemispherical region). In some embodiments, the two-dimensional shape can instead encompass rays extending from an angle in the range of from 0 to 30 degrees (or from 30 degrees to 60 degrees, or from 60 degrees to 90 degrees) to an angle in the range of from 90 to 120 degrees (or from 120 degrees to 150 degrees, or from 150 degrees to 180 degrees). In some embodiments, the range of directions in which the lighting device emits light can be non-symmetrical about any axis, i.e., different embodiments can have any suitable range of directions of light emission, which can be continuous or discontinuous (e.g., regions of ranges of emissions can be surrounded by regions of ranges in which light is not emitted). In some embodiments, the lighting device can emit light in at least 50% of all directions extending from a center of the lighting device (e.g., hemispherical being 50%), and in some embodiments at least 60%, 70%, 80%, 90% or more.

Solid state light emitter lighting systems (e.g., LED lighting systems) can offer a long operational lifetime relative to conventional incandescent and fluorescent bulbs. LED lighting system lifetime is typically measured by an “L70 lifetime”, i.e., a number of operational hours in which the light output of the LED lighting system does not degrade by more than 30%. Typically, an L70 lifetime of at least 25,000 hours is desirable, and has become a standard design goal. As used herein, L70 lifetime is defined by Illuminating Engineering Society Standard LM-80-08, entitled “IES Approved Method for Measuring Lumen Maintenance of LED Light Sources”, Sep. 22, 2008, ISBN No. 978-0-87995-227-3, also referred to herein as “LM-80”, the disclosure of which is hereby incorporated herein by reference in its entirety as if set forth fully herein.

Various embodiments are described herein with reference to “expected L70 lifetime.” Because the lifetimes of solid state lighting products are measured in the tens of thousands of hours, it is generally impractical to perform full term testing to measure the lifetime of the product. Therefore, projections of lifetime from test data on the system and/or light source are used to project the lifetime of the system. Such testing methods include, but are not limited to, the lifetime projections found in the ENERGY STAR Program Requirements cited above or described by the ASSIST method of lifetime prediction, as described in “ASSIST Recommends . . . LED Life For General Lighting: Definition of Life”, Volume 1, Issue 1, February 2005, the disclosure of which is hereby incorporated herein by reference as if set forth fully herein. Accordingly, the term “expected L70 lifetime” refers to the predicted L70 lifetime of a product as evidenced, for example, by the L70 lifetime projections of ENERGY STAR, ASSIST and/or a manufacturer's claims of lifetime.

Lighting devices according to some embodiments of the present inventive subject matter provide an expected L70 lifetime of at least 25,000 hours. Lighting devices according to some embodiments of the present inventive subject matter provide expected L70 lifetimes of at least 35,000 hours, and lighting devices according to some embodiments of the present inventive subject matter provide expected L70 lifetimes of at least 50,000 hours.

It would be especially desirable to provide a lighting device that comprises one or more solid state light emitters (and in which some or all of the light produced by the lighting device is generated by solid state light emitters), where the lighting device can be easily substituted (i.e., retrofitted or used in place of initially) for a conventional lamp (e.g., an incandescent lamp, a fluorescent lamp or other conventional types of lamps), for example, a lighting device (that comprises one or more solid state light emitters) that can be engaged with the same socket that the conventional lamp is engaged (a representative example being simply unscrewing an incandescent lamp from an Edison socket and threading in the Edison socket, in place of the incandescent lamp, a lighting device that comprises one or more solid state light emitters). In some aspects of the present inventive subject matter, such lighting devices are provided.

In some aspects of the present inventive subject matter, there are provided lighting devices that provide good efficiency and that are within the size and shape constraints of the lamp for which the lighting device is a replacement.

In some aspects of the present inventive subject matter, which can include or not include any of the features described elsewhere herein, there are provided lighting devices that provide sufficient lumen output (to be useful as a replacement for a conventional lamp), that provide good efficiency and that are within the size and shape constraints of the lamp for which the lighting device is a replacement. In some cases, “sufficient lumen output” means at least 75% of the lumen output of the lamp for which the lighting device is a replacement, and in some cases, at least 85%, 90%, 95%, 100%, 105%, 110%, 115%, 120% or 125% of the lumen output of the lamp for which the lighting device is a replacement.

Embodiments in accordance with the present inventive subject matter are described herein in detail in order to provide exact features of representative embodiments that are within the overall scope of the present inventive subject matter. The present inventive subject matter should not be understood to be limited to such detail.

Embodiments in accordance with the present inventive subject matter are also described with reference to cross-sectional (and/or plan view) illustrations that are schematic illustrations of idealized embodiments of the present inventive subject matter. As such, variations from the shapes of the illustrations as a result, for example, of manufacturing techniques and/or tolerances, are to be expected. Thus, embodiments of the present inventive subject matter should not be construed as being limited to the particular shapes of regions illustrated herein but are to include deviations in shapes that result, for example, from manufacturing. For example, a molded region illustrated or described as a rectangle will, typically, have rounded or curved features. Thus, the regions illustrated in the figures are schematic in nature and their shapes are not intended to illustrate the precise shape of a region of a device and are not intended to limit the scope of the present inventive subject matter.

The lighting devices illustrated herein are illustrated with reference to cross-sectional drawings. These cross sections may be rotated around a central axis to provide lighting devices that are circular in nature. Alternatively, the cross sections may be replicated to form sides of a polygon, such as a square, rectangle, pentagon, hexagon or the like, to provide a lighting device. Thus, in some embodiments, objects in a center of the cross-section may be surrounded, either completely or partially, by objects at the edges of the cross-section.

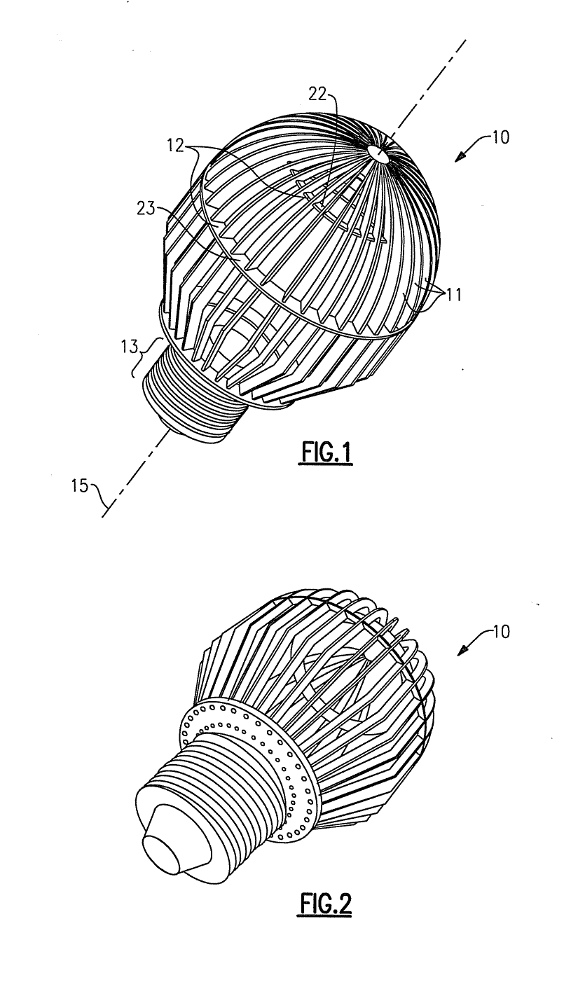

FIGS. 1 and 2 illustrate a lighting device 10 in accordance with the present inventive subject matter. FIG. 1 is a first perspective view of the lighting device 10, and FIG. 2 is a second perspective view of the lighting device 10.

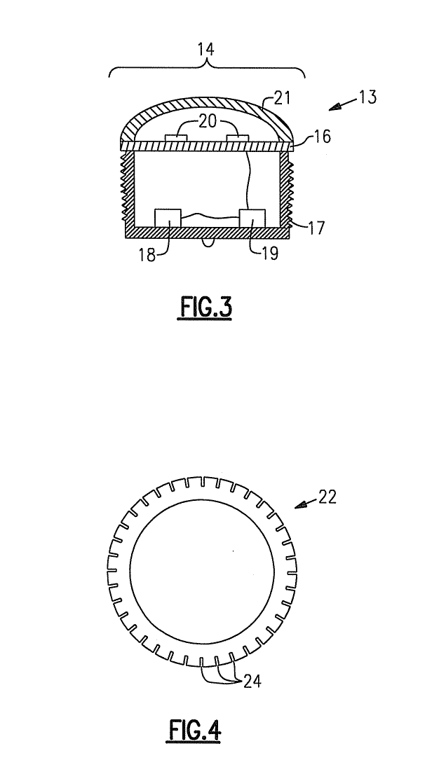

Referring to FIG. 1, the lighting device 10 comprises a plurality of longitudinal heat dissipation elements 11, two lateral heat dissipation elements 12 (a first lateral heat dissipation element 22 and a second lateral heat dissipation element 23), a base 13 and a light source 14. In the specific embodiment depicted in FIGS. 1 and 2, the lighting device has 36 longitudinal heat dissipation elements 11, each spaced evenly (i.e., about 10 degrees from each of its neighbors, relative to an axis 15 of the lighting device 10), but other embodiments can have any suitable number of longitudinal heat dissipation elements 11 spaced and shaped in any desired way (the shape and/or spacing of the longitudinal heat dissipation elements 11 can be uniform or non-uniform). In the specific embodiment depicted in FIGS. 1 and 2, the lighting device has two lateral heat dissipation elements 12, but other embodiments can have any suitable number of lateral heat dissipation elements 12 positioned and shaped in any suitable way. In the lighting device 10, both of the lateral heat dissipation elements 12 are annular, with top and bottom surfaces in planes that are perpendicular to the axis 15 of the lighting device 10. The base 13 comprises a base plate 16, a base element 17, a power supply 18 (see FIG. 3) and a driver 19. The outer surfaces of the base element 17 are shaped as an Edison plug, such that it can be received in an Edison socket.

The light source 14 comprises a plurality of solid state light emitters 20 and a diffuser 21, and is on the base 13. Energy (e.g., line voltage) can be delivered to the lighting device 10 through the Edison socket, into the power supply 18, then into the driver 19 and then into the solid state light emitters 20, whereby light can be emitted by the solid state light emitters 20 and the emitted light can pass through the diffuser 21.

FIG. 3 is a cross-sectional view of the base 13, showing the base plate 16, the base element 17, the power supply 18, the driver 19, the solid state light emitters 20 and the diffuser 21.

In this embodiment, the longitudinal heat dissipation elements 11 and the lateral heat dissipation elements 12 are reflective. Alternatively, some or all of the longitudinal heat dissipation elements 11 and/or the lateral heat dissipation elements 12 could be transparent, and/or portions of some or all of the longitudinal heat dissipation elements 11 and/or the lateral heat dissipation elements 12 could be transparent.

Optionally, the base element 17 can comprise one or more elements of higher heat conducting capability (e.g., one or more wires, bars, layers, particles, regions, heat pipes and/or slivers) positioned within the base element 17.

As can be seen in FIG. 1, in the lighting device 10 depicted in FIG. 1: portions of each of the longitudinal heat dissipation elements 11 are in the path of some of the light emitted by the solid state light emitters 20;

well more than 20% of a volume defined by an exterior of the lighting device 10 is exposed to ambient air;

for each of the longitudinal heat dissipation elements 11, the 25% of the surface area that is closest to the solid state light emitters 20 is exposed to ambient room air;

any line that passes through a center of the light source 14 and a point on a hemisphere whose circular edge is (1) centered on the center of the light source 14 and (2) positioned on a plane that is perpendicular to the axis 15 of the lighting device 10 defines an angle of not more than 15 degrees relative to at least one line that passes through the center of the light source 14 and at least one point on one of the longitudinal heat dissipation elements 11 of the lighting device;

more than 25 percent of light emitted by the solid state light emitters 20 is incident on one of the longitudinal heat dissipation elements 11 and/or one of the lateral heat dissipation elements 12, and more than 50 percent of the light emitted by the solid state light emitters 20 that is incident on one of the longitudinal heat dissipation elements 11 and/or one of the lateral heat dissipation elements 12 eventually exits the lighting device;

more than 25% of heat generated by the solid state light emitters 20 is dissipated in regions toward which light emitted by the solid state light emitters 20 is directed;

more than 75% of all of the light emitted by the solid state light emitters 20 that exits the lighting device passes through at least one of the longitudinal heat dissipation elements 11 and/or one of the lateral heat dissipation elements 12, is reflected by at least one of the longitudinal heat dissipation elements 11 and/or one of the lateral heat dissipation elements 12, or passes within ½ inch of at least one of the longitudinal heat dissipation elements 11 and/or one of the lateral heat dissipation elements 12;

for each of the longitudinal heat dissipation elements 11 and each of the lateral heat dissipation elements 12, more than 50% of an entire external surface area is exposed to ambient air outside the lighting device 10;

for each of the longitudinal heat dissipation elements 11, a first line extending through a center of the light source 14 and a center of gravity of that longitudinal heat dissipation element and a second line extending through a center of the light source 14 and, a center of gravity of either of the longitudinal heat dissipation elements 11 that are immediate neighbors of that longitudinal heat dissipation element define an angle of about 10 degrees;

for each of the longitudinal heat dissipation elements 11, a first plane that is defined by a major surface of that longitudinal heat dissipation element and a second plane that is defined by a major surface of either of the longitudinal heat dissipation elements 11 that are immediate neighbors of that longitudinal heat dissipation element define an angle of about 10 degrees, and the first plane and the second plane each include the axis 15 of the lighting device 10;

at least a portion of at least one of the longitudinal heat dissipation elements 11 is positioned in each of eight quadrants defined by first, second, third and fourth planes, each of the first, second, third and fourth planes including the axis 15 of the lighting device 10, the second plane being rotated clockwise 45 degrees relative to the first plane, the third plane being rotated clockwise 45 degrees relative to the second plane, the fourth plane being rotated clockwise 45 degrees relative to the third plane, whereby the first, second, third and fourth planes are evenly spaced, and none of the longitudinal heat dissipation elements 11 includes portions that are positioned in each of two or more of the eight quadrants;

at least a portion of at least one of the longitudinal heat dissipation elements 11 is positioned in each of thirty-two quadrants defined by first through sixteenth planes, each of the first through sixteenth planes including the axis 15 of the lighting device 10 and being evenly radially spaced, and none of the longitudinal heat dissipation elements 11 heat dissipation element includes portions that are positioned in each of two or more of the sixteen quadrants; and

the lighting device is an A lamp.

FIG. 4 depicts the first lateral heat dissipation element 22. As seen in FIG. 4, the first lateral heat dissipation element 22 consists of an annular element having a plurality of notches 24 spaced along its outer periphery.

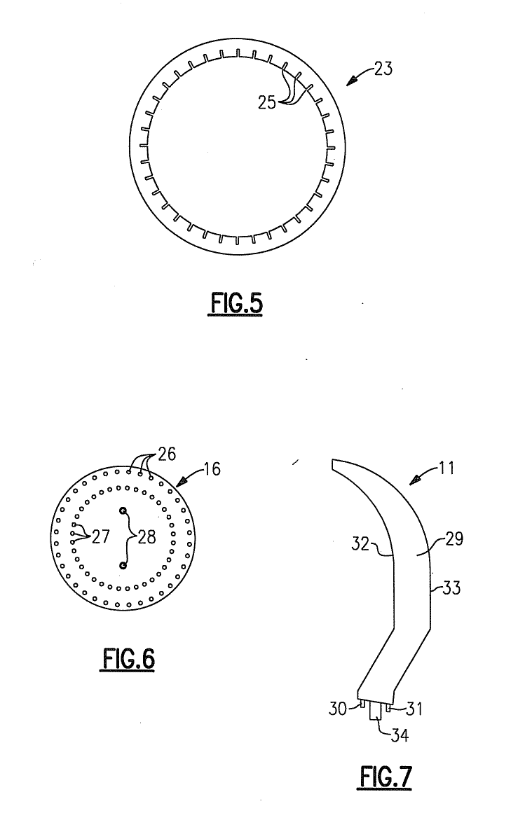

FIG. 5 depicts the second lateral heat dissipation element 23. As seen in FIG. 5, the second lateral heat dissipation element 23 consists of an annular element having a plurality of notches 25 spaced along its inner periphery.

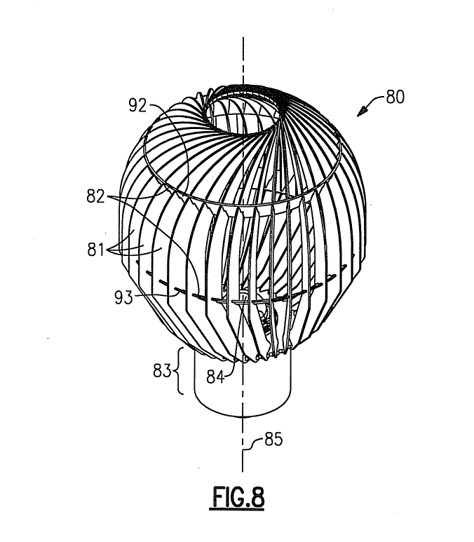

FIG. 6 depicts the base plate 16. As seen in FIG. 6, the base plate 16 consists of a circular element having an outer ring of apertures 26, an inner ring of apertures 27, and a pair of apertures 28 formed therethrough.

FIG. 7 depicts one of the longitudinal heat dissipation elements 11. In the lighting device 10, each of the thirty-two longitudinal heat dissipation elements 11 is substantially similar. The longitudinal heat dissipation element depicted in FIG. 7 comprises a main section 29, a first pin 30 and a second pin 31.

In the lighting device 10 depicted in FIG. 1, each of the longitudinal heat dissipation elements 11 is positioned such that its inner edge 32 engages a notch 24 in the first lateral heat dissipation element 22, its outer edge 33 engages a notch 25 in the second lateral heat dissipation element 23, the first pin 30 extends through one of the apertures in the inner ring of apertures 27 and the second pin 31 extends through one of the apertures in the outer ring of apertures 26 (in some embodiments, the first pin 30 and the second pin 31 extend through respective apertures of a pair of corresponding apertures, i.e., the apertures (one in the inner ring 27 and one in the outer ring 26) are aligned such that a line that extends through both defines an angle of not greater than 10 degrees relative to a line that extends through a center of the base plate 16 and the aperture in the inner ring 27.

In some embodiments, one or both of the pins 30 and 31 on any or all of the longitudinal heat dissipation elements 11 can be bent (e.g., about 90 degrees or to any other angle) on the side of the base plate 16 opposite the main section 29, to assist in holding the longitudinal heat dissipation element 11 relative to the base plate 16.

In some embodiments, one or more of the longitudinal heat dissipation elements can further include at least one tab, e.g., the heat dissipation element 11 shown in FIG. 7 includes a tab 34. The tab 34 can be bent to any desired extent, e.g., about 90 degrees, so that it includes a surface that is in contact with a surface of the base plate 16 (either on the same side of the base plate 16 as the longitudinal heat dissipation element 11 or on the other side), so as to provide enhanced thermal coupling between the heat dissipation element 11 and the base plate 16. In some of such embodiments, the tab 34 of each heat dissipation element 11 can abut the tab 34 of each adjacent heat dissipation element 11, i.e., the surface area of contact between the tabs 34 and the base plate 16 can be enhanced or even maximized.

In some embodiments, in the base plate 16, in place of some or all of the apertures 26 and 27, there can instead be provided a slot (or slots) or a groove (or grooves), into which the lower (in the orientation depicted in FIG. 7) portions (or tabs extending therefrom) of the heat dissipation elements 11 can be inserted.

In some embodiments (e.g., where the base plate 16 includes grooves), the lower portions (or tabs extending therefrom) of some or all of the heat dissipation elements can extend into, but not all the way through, the base plate 16.

In some embodiments (e.g., where the base plate 16 includes slots), the lower portions (or tabs extending therefrom) of some or all of the heat dissipation elements can extend all the way through the base plate 16. In some of such embodiments, the lower portions (or tabs extending therefrom) can be bent (e.g., about 90 degrees or to any other angle) on the side of the base plate 16 opposite the main section 29, to assist in holding the longitudinal heat dissipation element 11 relative to the base plate 16, and/or in order to insert the lower portions (or tabs extending therefrom) of one or more heat dissipation elements into corresponding slots in the base plate 16, the base plate 16 can be heated to cause the slots to be at least slightly larger, and then the lower portions (or tabs extending therefrom) of the one or more heat dissipation elements can be inserted into the corresponding slots (after which the base plate 16 can be cooled back down).

In some embodiments, rather than all of the heat dissipation elements 11 having pins 30 and 31 and the base plate 16 having apertures 26 and 27, some or all of the pins 30 and 31 can instead be bent tabs with apertures and some or all of the apertures 26 and 27 can instead be pins that extend through one or more corresponding apertures in the bent tabs on the heat dissipation element(s). For instance, in place of the pin 31 on one or more of the heat dissipation elements 11 there can instead be a tab with an aperture (along with the pin 30), and in place of the corresponding aperture 26 on the base plate 16 there can instead be a pin (along with the corresponding aperture 27).

The apertures 28 can be used for any desired purpose (more apertures can be provided, if necessary and/or desired), e.g., screws can be threaded through the apertures 28 in order to secure a light emitter (e.g., an MXP chip) onto the base plate 16, and/or wires that provide current to a light emitter can be threaded through the apertures 28.

Some embodiments of lighting devices in accordance with the present inventive subject matter are similar to the one depicted in FIGS. 1-7, except that instead of providing solid state light emitters on the base plate 16, the solid state light emitters are positioned at various locations on the longitudinal heat dissipation elements 11 and/or on the lateral heat dissipation elements 12. In some of such embodiments, no diffuser 21 is included. Alternatively, in some of such embodiments, a diffuser can be provided (e.g., in the shape of a globe), e.g., just inside the longitudinal heat dissipation elements 11, optionally with luminescent material in the diffuser, and some or all of the solid state light emitters can be positioned within the diffuser. Optionally, in such embodiments, a luminescent material-containing structure can be provided that comprises one or more luminescent materials (e.g., in the form of a solid transparent structure with particles of luminescent material dispersed therein), with some or all of the solid state light emitters being located such that at least some of the light emitted by the one or more solid state light emitters will be incident upon the luminescent material-containing structure (e.g., the luminescent material-containing structure can be in the shape of a globe, e.g., located just inside the longitudinal heat dissipation elements 11).

In embodiments in which solid state light emitters are positioned at various locations on the longitudinal heat dissipation elements 11 and/or on the lateral heat dissipation elements 12, the solid state light emitters that are positioned at various locations on the longitudinal heat dissipation elements 11 and/or on the lateral heat dissipation elements 12 can be supplied with electricity in any desired way, persons of skill in the art being familiar with a variety of ways in which electricity could be supplied to the solid state light emitters that are positioned on the longitudinal heat dissipation elements 11 and/or on the lateral heat dissipation elements 12 (e.g., traces formed on the longitudinal heat dissipation elements 11 and/or on the lateral heat dissipation elements 12).

In some embodiments in which solid state light emitters are positioned at various locations on the longitudinal heat dissipation elements 11 and/or on the lateral heat dissipation elements 12, which can include or not include any of the features described elsewhere herein, at least one of the solid state light emitters can be exposed, e.g., to ambient room air.

In some embodiments in which solid state light emitters are positioned at various locations on the longitudinal heat dissipation elements 11 and/or on the lateral heat dissipation elements 12, which can include or not include any of the features described elsewhere herein, an ambient medium (e.g., ambient room air) can reach the solid state light emitter in at least fifteen different routes that are separated from each other by at least one heat dissipation element. For example, in an embodiment that is similar to the lighting device depicted in FIGS. 1-7, except that at least one of the solid state light emitters is positioned at various locations on the longitudinal heat dissipation elements 11 and/or on the lateral heat dissipation elements 12, ambient room air can reach the at least one solid state light emitter in 96 different routes, each of the routes being separated from each of the other routes by at least one longitudinal heat dissipation element and/or at least one lateral heat dissipation element.

In some embodiments in which at least one of the solid state light emitters is positioned at various locations on the longitudinal heat dissipation elements 11 and/or on the lateral heat dissipation elements 12, if the one or more solid state light emitters is/are illuminated, for at least one of the solid state light emitter(s), at least some light emitted exits the lighting device in a first direction and at least some exits the lighting device in a second direction, the first direction defining an angle of at least 160 degrees relative to the second direction.

In the various lighting devices according to the present inventive subject matter, reflective heat dissipation elements can allow fairly uniform light distribution because of virtual images of the source. In devices where a diffuse coating or coatings is/are provided on one or more of the heat dissipation elements (and in many cases even more so where a specular coating or coatings is/are provided on one or more of the heat dissipation elements), the heat dissipation elements may need to be bent or twisted in the z-direction to prevent direct view of the source.

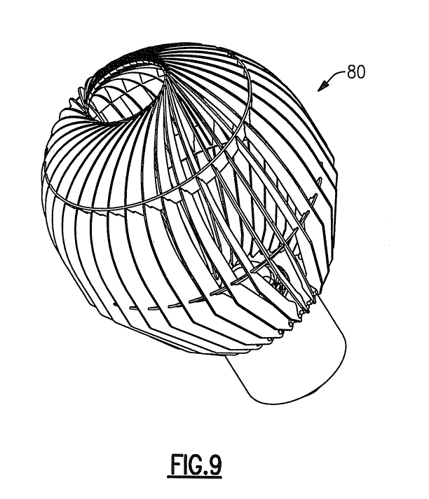

FIGS. 8 and 9 illustrate another lighting device 80 in accordance with the present inventive subject matter. FIG. 8 is a first perspective view of the lighting device 80, and FIG. 9 is a second perspective view of the lighting device 80.

Referring to FIG. 8, the lighting device 80 comprises a plurality of longitudinal heat dissipation elements 81, two lateral heat dissipation elements 82 (a first lateral heat dissipation element 92 and a second lateral heat dissipation element 93), a base 83 and a light source 84. In the lighting device 80, unlike in the lighting device 10, the notches in the lateral heat dissipation elements 82 are not aligned with the axis 85 of the lighting device 80, so that the top (in the orientation depicted in FIG. 8) ends of the longitudinal heat dissipation elements 81 do not point toward the axis 85 of the lighting device 80, as seen in FIGS. 8 and 9. By positioning the longitudinal heat dissipation elements 81 in the manner depicted in FIGS. 8 and 9, each of the longitudinal heat dissipation elements 81 is offset, i.e., twisted or bent in the z-direction, thereby reducing or preventing direct view of the light source (or sources).

In the specific embodiment depicted in FIGS. 8 and 9, the lighting device has 36 longitudinal heat dissipation elements 81, each spaced evenly (i.e., in locations between the first lateral heat dissipation element 92 and the second lateral heat dissipation element 93 about 10 degrees from each of its neighbors, relative to the axis 85 of the lighting device 80), but other embodiments can have any suitable number of longitudinal heat dissipation elements 81 spaced and shaped in any suitable way (the shape and/or spacing of the longitudinal heat dissipation elements 81 can be uniform or non-uniform). In the specific embodiment depicted in FIGS. 8 and 9, the lighting device has two lateral heat dissipation elements 82, but other embodiments can have any suitable number of lateral heat dissipation elements 82 positioned and shaped in any suitable way. In the lighting device 80, both of the lateral heat dissipation elements 82 are annular, with top and bottom surfaces in planes that are perpendicular to the axis 85 of the lighting device 80. The outer surfaces of the base 83 are shaped as an Edison plug, such that it can be received in an Edison socket.

In this embodiment, the longitudinal heat dissipation elements 81 and the lateral heat dissipation elements 82 are reflective. Alternatively, some or all of the longitudinal heat dissipation elements 81 and/or the lateral heat dissipation elements 82 could be transparent, and/or portions of some or all of the longitudinal heat dissipation elements 81 and/or the lateral heat dissipation elements 82 could be transparent.

Optionally, the base element 83 can comprise one or more elements of higher heat conducting capability (e.g., one or more wires, bars, layers, particles, regions, heat pipes and/or slivers) positioned within the heat dissipation element(s).

If desired, the longitudinal heat dissipation elements 81 can be twisted in order to reduce the size of the opening in the top (in the orientation as shown in FIG. 8), increase the size of the opening in the top, or substantially eliminate the opening in the top.

Persons skilled in the art can readily assemble the lighting devices described above in a variety of suitable ways. For instance, one way would be to feed the longitudinal heat dissipation elements onto the lateral heat dissipation elements and the base by putting each longitudinal heat dissipation element between the two lateral heat dissipation elements and engaging it in the notch in the first (top as oriented in FIG. 8) lateral heat dissipation element, then rotating it down to engage in the notch in the second (bottom as oriented in FIG. 8) lateral heat dissipation element and then into the notch in the base. In some instances, it may be helpful to assemble two of the longitudinal heat dissipation elements into the base first at about 120 degrees apart and slip the lateral heat dissipation elements into them to position them and then add the rest of the longitudinal heat dissipation elements.

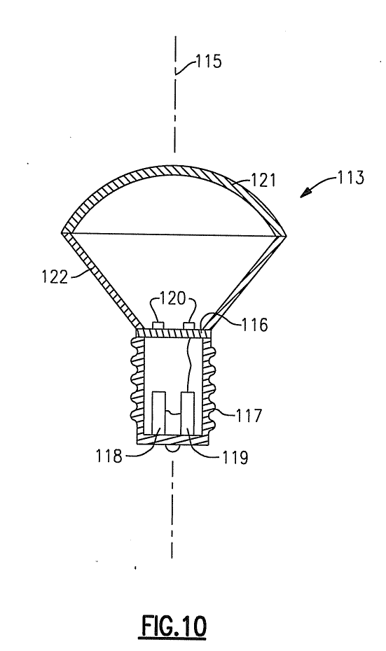

FIG. 10 is a cross-sectional view of a base 113 that can be used in lighting devices according to the present inventive subject matter, e.g., in place of the base 13 in the lighting device depicted in FIGS. 1-7 or in place of the base 83 in the lighting device depicted in FIGS. 8 and 9. Referring to FIG. 10, the base 113 comprises a base plate 116, a base element 117, a power supply 118, a driver 119, solid state light emitters 120, a diffuser 121 and a reflective element 122. In lighting devices that include the base 113, more than 90 percent of all light emitted by the solid state light emitters 120 that exit the lighting device travels in directions that define angles that are not greater than 60 degrees relative to a line that extends through an axis 115 of the base 113.

Persons of skill in the art are familiar with, and can readily envision, and have ready access to, a variety of reflective materials that can be used to make a reflective element such as the reflective element 122, and any of such reflective materials can be employed in embodiments in accordance with the present inventive subject matter. Persons of skill in the art are familiar with, and can readily obtain, a wide variety of reflective materials for use in such reflective elements. A representative example of a suitable reflective material for such purposes is a material marketed by Furukawa (a Japanese corporation) under the trademark MCPET®. A reflective material can be supported, if desired, by any suitable structure made of any suitable material.

As described above, some embodiments can comprise two or more solid state light emitters. By having multiple solid state light emitters (as opposed to a single point source of light), the lighting device is affected less by shadowing—that is, if an object that is smaller than the light emitting area is placed in front of the light emitting area, only a portion of the light rays would be blocked. Since the light sources follow the Huygens principle (each source acts as a spherical wave front), the viewing of a shadow is not seen, and only a slight dimming of the illuminated source is seen (in contrast to where a single filament is employed, where the light would be substantially dimmed and a shadow would be observed).

While certain embodiments of the present inventive subject matter have been illustrated with reference to specific combinations of elements, various other combinations may also be provided without departing from the teachings of the present inventive subject matter. Thus, the present inventive subject matter should not be construed as being limited to the particular exemplary embodiments described herein and illustrated in the Figures, but may also encompass combinations of elements of the various illustrated embodiments.

Many alterations and modifications may be made by those having ordinary skill in the art, given the benefit of the present disclosure, without departing from the spirit and scope of the inventive subject matter. Therefore, it must be understood that the illustrated embodiments have been set forth only for the purposes of example, and that it should not be taken as limiting the inventive subject matter as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the inventive subject matter.

Any two or more structural parts of the lighting devices described herein can be integrated. Any structural part of the lighting devices described herein can be provided in two or more parts (which may be held together in any known way, e.g., with adhesive, screws, bolts, rivets, staples, etc.).

1. A lighting device, comprising:
at least a first solid state light emitter; and
at least a first heat dissipation element and a second heat dissipation element,
the first heat dissipation element and the first solid state light emitter positioned and oriented relative to one another such that if the first solid state light emitter is illuminated, at least a portion of the first heat dissipation element is in the path of at least some of the light emitted by the first solid state light emitter.

2. A lighting device as recited in claim 1, wherein at least 20% of a volume defined by an exterior of the lighting device is exposed.

3. A lighting device as recited in claim 1, wherein the first solid state light emitter is exposed to an ambient medium that is outside the lighting device.

4. A lighting device as recited in claim 3, wherein the ambient medium can reach the solid state light emitter in at least fifteen different routes that are separated from each other by at least one heat dissipation element.

5. A lighting device as recited in claim 1, wherein:
at least 25 percent of light emitted by the first solid state light emitter is incident on one of the heat dissipation elements, and at least 50 percent of the light emitted by the first solid state light emitter that is incident on one of the heat dissipation elements eventually exits the lighting device.

6. A lighting device as recited in claim 1, wherein at least 75% of all of the light emitted by the first solid state light emitter that exits the lighting device passes through at least one heat dissipation element, is reflected by at least one heat dissipation element or passes within one inch of at least one heat dissipation element.

7. A lighting device as recited in claim 1, wherein at least 50% of an entire external surface area of the first heat dissipation element and at least 50% of an entire external surface area of the second heat dissipation element are exposed.

8. A lighting device as recited in claim 1, wherein a first line extending through a center of the first solid state light emitter and a center of gravity of the first heat dissipation element and a second line extending through a center of the first solid state light emitter and a center of gravity of the second heat dissipation element define an angle of not more than 80 degrees.

9. A lighting device as recited in claim 1, wherein:
the first heat dissipation element has a first surface in a first plane,
the second heat dissipation element has a second surface in a second plane, and
the first plane defines an angle of between 5 degrees and 80 degrees relative to the second plane.

10. A lighting device as recited in claim 9, wherein the first plane and the second plane each include an axis of the lighting device.

11. A lighting device as recited in claim 9, wherein:
the lighting device comprises at least a third heat dissipation element, a fourth heat dissipation element and a fifth heat dissipation element in addition to the first heat dissipation element and the second heat dissipation element,
the third heat dissipation element has a third surface in a third plane,
the fourth heat dissipation element has a fourth surface in a fourth plane,
the fifth heat dissipation element has a fifth surface in a fifth plane, and
each of the first plane, the second plane, the third plane, the fourth plane and the fifth plane defines an angle of not more than 80 degrees with respect to each of the others of the first plane, the second plane, the third plane, the fourth plane and the fifth plane.

12. A lighting device as recited in claim 11, wherein the first plane, the second plane, the third plane, the fourth plane and the fifth plane each include an axis of the lighting device.

13. A lighting device as recited in claim 9, wherein:
the lighting device comprises at least a third heat dissipation element, a fourth heat dissipation element, a fifth heat dissipation element, a sixth heat dissipation element, a seventh heat dissipation element and an eighth heat dissipation element in addition to the first heat dissipation element and the second heat dissipation element,
the third heat dissipation element has a third surface in a third plane,
the fourth heat dissipation element has a fourth surface in a fourth plane,
the fifth heat dissipation element has a fifth surface in a fifth plane,
the sixth heat dissipation element has a sixth surface in a sixth plane,
the seventh heat dissipation element has a seventh surface in a seventh plane,
the eighth heat dissipation element has an eighth surface in an eighth plane, and
each of the first plane, the second plane, the third plane, the fourth plane, the fifth plane, the sixth plane, the seventh plane and the eighth plane defines an angle of not more than 80 degrees with respect to each of the others of the first plane, the second plane, the third plane, the fourth plane, the fifth plane, the sixth plane, the seventh plane and the eighth plane.

14. A lighting device as recited in claim 1, wherein at least a portion of at least one of the heat dissipation elements is transparent or reflective.

15. A lighting device as recited in claim 1, wherein if the first solid state light emitter is illuminated, at least some light emitted by the at least a first solid state light emitter exits the lighting device in a first direction and at least some light emitted by the at least a first solid state light emitter exits the lighting device in a second direction, the first direction defining an angle of at least 90 degrees relative to the second direction.

16. A lighting device as recited in claim 1, wherein:
at least a portion of at least one heat dissipation element is in each of eight quadrants defined by first, second, third and fourth planes, each of the first, second, third and fourth planes including an axis of the lighting device, the second plane rotated clockwise 45 degrees relative to the first plane, the third plane rotated clockwise 45 degrees relative to the second plane, the fourth plane rotated clockwise 45 degrees relative to the third plane, whereby the first, second, third and fourth planes are evenly spaced, and
no heat dissipation element includes portions that are in each of three or more of the eight quadrants.

17. A lighting device as recited in claim 1, wherein:
at least a portion of at least one heat dissipation element is in each of sixteen quadrants defined by first through eighth planes, each of the first through eighth planes including an axis of the lighting device and being evenly radially spaced, and
no heat dissipation element includes portions that are in each of three or more of the sixteen quadrants.

18. A lighting device as recited in claim 1, wherein:
at least a portion of at least one heat dissipation element is in each of thirty-two quadrants defined by first through sixteenth planes, each of the first through sixteenth planes including an axis of the lighting device and being evenly radially spaced, and
no heat dissipation element includes portions that are in each of three or more of the thirty-two quadrants.

19. A lighting device as recited in claim 1, wherein the lighting device is an A lamp.

20. A lighting device as recited in claim 1, wherein at least a first portion of the first heat dissipation element is devoid of transparency, the first portion in the path of at least some of the light emitted by the first solid state light emitter.

21. A lighting device, comprising:
at least a first solid state light emitter; and
at least a first heat dissipation element and a second heat dissipation element,
at least half of the 25% of the surface area of the first heat dissipation element that is closest to the first solid state light emitter being exposed.

22. A lighting device as recited in claim 21, wherein at least 75% of all of the light emitted by the first solid state light emitter that exits the lighting device passes through at least one heat dissipation element, is reflected by at least one heat dissipation element or passes within one inch of at least one heat dissipation element.

23. A lighting device as recited in claim 21, wherein at least a portion of at least one of the heat dissipation elements is transparent or reflective.

24. A lighting device as recited in claim 21, wherein the lighting device is an A lamp.

25. A lighting device, comprising:
at least a first solid state light emitter; and
at least first and second heat dissipation elements, at least a portion of at least one of the heat dissipation elements being transparent or reflective,
wherein at least 90 percent of all light emitted by the first solid state light emitter that exits the lighting device travels in directions that define angles that are not greater than 60 degrees relative to a line that extends through the first solid state light emitter.

26. A lighting device as recited in claim 25, wherein at least 75% of all of the light emitted by the first solid state light emitter that exits the lighting device passes through at least one heat dissipation element, is reflected by at least one heat dissipation element or passes within one inch of at least one heat dissipation element.

27. A lighting device as recited in claim 25, wherein the lighting device is an A lamp.

28. A lighting device, comprising:
at least a first solid state light emitter; and
at least first and second heat dissipation elements,
any line that passes through a center of the first solid state light emitter and a point on a hemisphere whose circular edge is (1) centered on the center of the first solid state light emitter and (2) on a plane that is perpendicular to an axis of the lighting device, defines an angle of not more than 45 degrees relative to at least one line that passes through the center of the first solid state light emitter and at least one point on a heat dissipation element of the lighting device.

29. A lighting device as recited in claim 28, wherein at least 75% of all of the light emitted by the first solid state light emitter that exits the lighting device passes through at least one heat dissipation element, is reflected by at least one heat dissipation element or passes within one inch of at least one heat dissipation element.

30. A lighting device as recited in claim 28, wherein the lighting device is an A lamp.

31. A lighting device, comprising:
at least a first solid state light emitter; and
at least first and second heat dissipation elements,
wherein at least 25% of heat generated by the at least one solid state light emitter is dissipated in regions toward which light emitted by the at least one solid state light emitter is directed.

32. A lighting device as recited in claim 31, wherein at least 75% of all of the light emitted by the first solid state light emitter that exits the lighting device passes through at least one heat dissipation element, is reflected by at least one heat dissipation element or passes within one inch of at least one heat dissipation element.

33. A lighting device as recited in claim 31, wherein the lighting device is an A lamp.

34. A lighting device, comprising:
at least a first solid state light emitter; and
means for dissipating heat.

35. A lighting device as recited in claim 34, wherein the means for dissipating heat comprises at least a first heat dissipation element and a second heat dissipation element,
the first heat dissipation elements and the first solid state light emitter positioned and oriented relative to one another such that if the first solid state light emitter is illuminated, at least a portion of the first heat dissipation element is in the path of at least some of the light emitted by the first solid state light emitter.

36. A lighting device as recited in claim 34, wherein the means for dissipating heat comprises at least two heat dissipation elements, and wherein at least half of the 25% of the surface area of the first heat dissipation element that is closest to the first solid state light emitter is exposed to an ambient medium.

37. A lighting device as recited in claim 34, wherein the means for dissipating heat comprises at least two heat dissipation elements, and wherein at least 90 percent of all light emitted by the first solid state light emitter that exits the lighting device travels in directions that define angles that are not greater than 60 degrees relative to a line that extends through the first solid state light emitter.

38. A lighting device as recited in claim 34, wherein the means for dissipating heat comprises at least two heat dissipation elements, and any line that passes through a center of the first solid state light emitter and a point on a hemisphere whose circular edge is (1) centered on the center of the first solid state light emitter and (2) on a plane that is perpendicular to an axis of the lighting device, defines an angle of not more than 45 degrees relative to at least one line that passes through the center of the first solid state light emitter and at least one point on a heat dissipation element of the lighting device.

39. A lighting device as recited in claim 34, wherein the means for dissipating heat comprises at least two heat dissipation elements, and wherein at least 25% of heat generated by the at least one solid state light emitter is dissipated in regions toward which light emitted by the at least one solid state light emitter is directed.

40. A lighting device, comprising:
at least a first solid state light emitter; and
at least a first heat dissipation element, at least a first portion of the first heat dissipation element devoid of transparency,
the first heat dissipation element and the first solid state light emitter positioned and oriented relative to one another such that if the first solid state light emitter is illuminated, at least the first portion of the first heat dissipation element is in the path of at least some of the light emitted by the first solid state light emitter.

41. A lighting device, comprising:
an electrical connector;
at least a first solid state light emitter; and
at least a first heat dissipation element, at least a portion of the first heat dissipation element on a first side of a first plane extending through the first solid state light emitter, the electrical connector on a second side of the first plane.

42. A lighting device as recited in claim 41, wherein at least a first portion of the first heat dissipation element devoid of transparency.

43. A lighting device as recited in claim 41, wherein the first plane is an emission plane of the first solid state light emitter.

44. A lighting device as recited in claim 41, wherein the electrical connector is an Edison plug.
